(19) United States
(12) Patent Application Publication
(10) Pub. No.: US 2007/0061711 A1
(43) Pub. Date: Mar. 15, 2007

(54) Management and rendering of RSS content

(76) Inventors: William K. Bodin, Austin, TX (US); David Jaramillo, Lake Worth, FL (US); Jerry W. Redman, Cedar Park, TX (US); Derral C. Thorson, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/226,751

(22) Filed: Sep. 14, 2005

(51) Int. Cl. G06F 17/00

(52) U.S. Cl. 715/523

(57) ABSTRACT

Methods, systems, and products are disclosed for management and rendering of RSS content, including receiving aggregated RSS content in native form, synthesizing the items of the aggregated native form RSS content into synthesized RSS content, and presenting the synthesized RSS content. Synthesizing items of the aggregated native form RSS content into synthesized RSS content may also include translating aspects of the items of the aggregated native form RSS content into uniform text and markup. Management and rendering of RSS content may also include receiving RSS preferences from a user and creating prioritization rules in dependence upon the RSS preferences for synthesizing RSS content.

### BACKGROUND OF THE INVENTION

1. Field of the Invention

The field of the invention is data processing, or, more specifically, methods, systems, and products for management and rendering of RSS content.

2. Description of Related Art

Despite having more access to data and having more devices to access that data, users are often time constrained. One reason for this time constraint is that users typically must access data of disparate data types from disparate data sources on data type-specific devices using data type-specific applications. One or more such data type-specific devices may be cumbersome for use at a particular time due to any number of external circumstances. Examples of external circumstances that may make data type-specific devices cumbersome to use include crowded locations, uncomfortable locations such as a train or car, user activity such as walking, visually intensive activities such as driving, and others as will occur to those of skill in the art. There is therefore an ongoing need for data management and data rendering for disparate data types that provides access to uniform data type access to content from disparate data sources.

### SUMMARY OF THE INVENTION

Methods, systems, and products are disclosed for management and rendering of RSS content, including receiving aggregated RSS content in native form, synthesizing the items of the aggregated native form RSS content into synthesized RSS content, and presenting the synthesized RSS content. Synthesizing items of the aggregated native form RSS content into synthesized RSS content may also include translating aspects of the items of the aggregated native form RSS content into uniform text and markup. Management and rendering of RSS content may also include receiving RSS preferences from a user and creating prioritization rules in dependence upon the RSS preferences for synthesizing RSS content.

Management and rendering of RSS content may also include aggregating RSS content in native form. Aggregating RSS content in native form may also include identifying new items in an RSS feed in native form and retrieving the identified new items from an RSS content source. Identifying new items in an RSS feed in native form may also include identifying the new items in dependence upon RSS aggregation preferences from a user. Retrieving the identified new items from an RSS content source may also include retrieving the new items in dependence upon RSS aggregation preferences from a user.

Management and rendering of RSS content may also include identifying, according to prioritization rules, priority characteristics in the aggregated native form RSS content. Synthesizing the items of the aggregated native form RSS content into synthesized RSS content may also include prioritizing the items of the synthesized RSS content according to the priority characteristics. Presenting the synthesized RSS content may also include presenting the prioritized synthesized RSS content.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for data management and data rendering for disparate data types according to the present invention.

FIG. 2 sets forth a block diagram of automated computing machinery comprising an exemplary computer useful in data management and data rendering for disparate data types according to the present invention.

FIG. 3 sets forth a block diagram depicting a system for data management and data rendering for disparate data types according to the present invention.

FIG. 4 sets forth a flow chart illustrating an exemplary method for data management and data rendering for disparate data types according to the present invention.

FIG. 4A sets forth a flow chart illustrating an exemplary method for data management and data rendering for disparate data types according to the present invention.

FIG. 4B sets forth a line drawing of a browser in a data management and data rendering module operating according to the present invention.

FIG. 4C sets forth a line drawing of a browser in a data management and data rendering module further operating in according to the present invention.

FIG. 5 sets forth a flow chart illustrating an exemplary method for aggregating data of disparate data types from disparate data sources according to the present invention.

FIG. 5A sets forth a flow chart illustrating an exemplary method for aggregating data of disparate data types from disparate data sources in dependence upon the aggregation preferences according to the present invention.

FIG. 6 sets forth a flow chart illustrating an exemplary method for retrieving, from the identified data source, the requested data according to the present invention.

FIG. 7 sets forth a flow chart illustrating an exemplary method for aggregating data of disparate data types from disparate data sources according to the present invention.

FIG. 8 sets forth a flow chart illustrating an exemplary method for aggregating data of disparate data types from disparate data sources according to the present invention.

FIG. 9 sets forth a flow chart illustrating an exemplary method for synthesizing aggregated data of disparate data types into data of a uniform data type according to the present invention.

FIG. 10 sets forth a flow chart illustrating an exemplary method for synthesizing aggregated data of disparate data types into data of a uniform data type according to the present invention.

FIG. 10A sets forth a flow chart illustrating an exemplary method for synthesizing the aggregated data of disparate data types into data of a uniform data type in dependence upon synthesis preferences.

FIG. 10B sets forth a flow chart illustrating an exemplary method for management and rendering of RSS content according to the present invention.

FIG. 10C sets forth a flow chart illustrating a further exemplary method for management and rendering of RSS content according to the present invention.

FIG. 10D sets forth a flow chart illustrating an exemplary method for creating prioritization rules from user defined RSS preferences.

FIG. 11 sets forth a flow chart illustrating an exemplary method for identifying an action in dependence upon the synthesized data according to the present invention.

FIG. 12 sets forth a flow chart illustrating an exemplary method for channelizing the synthesized data according to the present invention

### DETAILED DESCRIPTION OF EXEMPLARY EMBODIMENTS

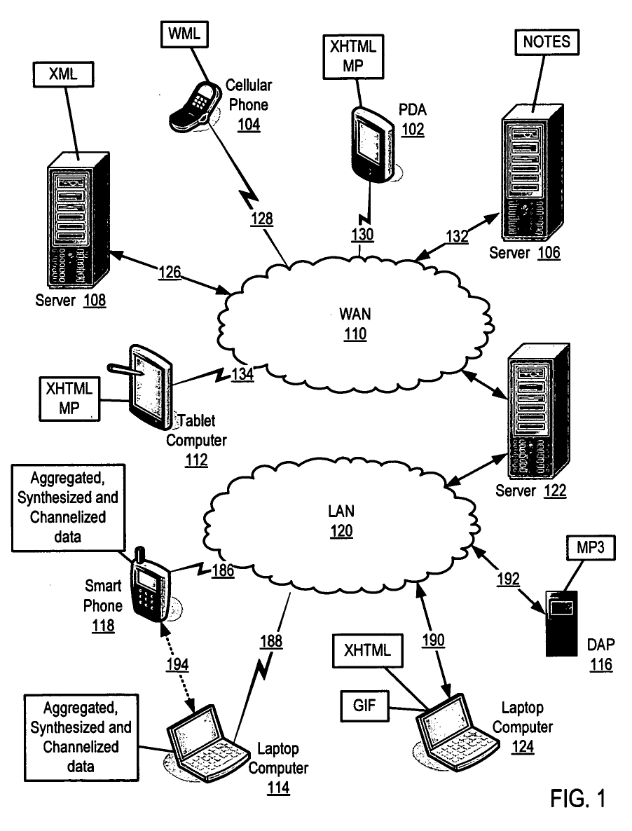

Exemplary methods, systems, and products for data management and data rendering for disparate data types and for data customization for data of disparate data types according to embodiments of the present invention are described with reference to the accompanying drawings, beginning with FIG. 1. FIG. 1 sets forth a network diagram illustrating an exemplary system for data management and data rendering for disparate data types according to embodiments of the present invention. The system of FIG. 1 operates generally to manage and render data for disparate data types according to embodiments of the present invention by aggregating data of disparate data types from disparate data sources, synthesizing the aggregated data of disparate data types into data of a uniform data type, identifying an action in dependence upon the synthesized data, and executing the identified action.

Disparate data types are data of different kind and form. That is, disparate data types are data of different kinds. The distinctions in data that define the disparate data types may include a difference in data structure, file format, protocol in which the data is transmitted, and other distinctions as will occur to those of skill in the art. Examples of disparate data types include MPEG-1 Audio Layer 3 (‘MP3’) files,

Extensible markup language documents (‘XML’), email documents, and so on as will occur to those of skill in the art. Disparate data types typically must be rendered on data type-specific devices. For example, an MPEG-1 Audio Layer 3 (‘MP3’) file is typically played by an MP3 player, a Wireless Markup Language (‘WML’) file is typically accessed by a wireless device, and so on.

The term disparate data sources means sources of data of disparate data types. Such data sources may be any device or network location capable of providing access to data of a disparate data type. Examples of disparate data sources include servers serving up files, web sites, cellular phones, PDAs, MP3 players, and so on as will occur to those of skill in the art.

The system of FIG. 1 includes a number of devices operating as disparate data sources connected for data communications in networks. The data processing system of FIG. 1 includes a wide area network (“WAN”) (110) and a local area network (“LAN”) (120). “LAN” is an abbreviation for “local area network.” A LAN is a computer network that spans a relatively small area. Many LANs are confined to a single building or group of buildings. However, one LAN can be connected to other LANs over any distance via telephone lines and radio waves. A system of LANs connected in this way is called a wide-area network (WAN). The Internet is an example of a WAN.

In the example of FIG. 1, server (122) operates as a gateway between the LAN (120) and the WAN (110). The network connection aspect of the architecture of FIG. 1 is only for explanation, not for limitation. In fact, systems for data management and data rendering for disparate data types according to embodiments of the present invention may be connected as LANs, WANs, intranets, internets, the Internet, webs, the World Wide Web itself, or other connections as will occur to those of skill in the art. Such networks are media that may be used to provide data communications connections between various devices and computers connected together within an overall data processing system.

In the example of FIG. 1, a plurality of devices are connected to a LAN and WAN respectively, each implementing a data source and each having stored upon it data of a particular data type. In the example of FIG. 1, a server (108) is connected to the WAN through a wireline connection (126). The server (108) of FIG. 1 is a data source for an RSS feed, which the server delivers in the form of an XML file. RSS is a family of XML file formats for web syndication used by news websites and weblogs. The abbreviation is used to refer to the following standards: Rich Site Summary (RSS 0.91), RDF Site Summary (RSS 0.9, 1.0 and 1.1), and Really Simple Syndication (RSS 2.0). The RSS formats provide web content or summaries of web content together with links to the full versions of the content, and other meta-data. This information is delivered as an XML file called RSS feed, webfeed, RSS stream, or RSS channel.

In the example of FIG. 1, another server (106) is connected to the WAN through a wireline connection (132). The server (106) of FIG. 1 is a data source for data stored as a Lotus NOTES file. In the example of FIG. 1, a personal digital assistant (‘PDA’) (102) is connected to the WAN through a wireless connection (130). The PDA is a data source for data stored in the form of an XHTML Mobile Profile (‘XHTML MP’) document.

In the example of FIG. 1, a cellular phone (104) is connected to the WAN through a wireless connection (128). The cellular phone is a data source for data stored as a Wireless Markup Language (‘WML’) file. In the example of FIG. 1, a tablet computer (112) is connected to the WAN through a wireless connection (134). The tablet computer (112) is a data source for data stored in the form of an XHTML MP document.

The system of FIG. 1 also includes a digital audio player (‘DAP’) (116). The DAP (116) is connected to the LAN through a wireline connection (192). The digital audio player (‘DAP’) (116) of FIG. 1 is a data source for data stored as an MP3 file. The system of FIG. 1 also includes a laptop computer (124). The laptop computer is connected to the LAN through a wireline connection (190). The laptop computer (124) of FIG. 1 is a data source data stored as a Graphics Interchange Format (‘GIF’) file. The laptop computer (124) of FIG. 1 is also a data source for data in the form of Extensible Hypertext Markup Language (‘XHTML’) documents.

The system of FIG. 1 includes a laptop computer (114) and a smart phone (118) each having installed upon it a data management and rendering module proving uniform access to the data of disparate data types available from the disparate data sources. The exemplary laptop computer (114) of FIG. 1 connects to the LAN through a wireless connection (188). The exemplary smart phone (118) of FIG. 1 also connects to the LAN through a wireless connection (186). The laptop computer (114) and smart phone (118) of FIG. 1 have installed and running on them software capable generally of data management and data rendering for disparate data types by aggregating data of disparate data types from disparate data sources; synthesizing the aggregated data of disparate data types into data of a uniform data type; identifying an action in dependence upon the synthesized data; and executing the identified action. The laptop computer (114) and smart phone (118) of FIG. 1 also have installed and running on them a customization module capable of receiving aggregation preferences from a user and receiving synthesis preferences from a user for data customization.

Aggregated data is the accumulation, in a single location, of data of disparate types. This location of the aggregated data may be either physical, such as, for example, on a single computer containing aggregated data, or logical, such as, for example, a single interface providing access to the aggregated data.

Synthesized data is aggregated data which has been synthesized into data of a uniform data type. The uniform data type may be implemented as text content and markup which has been translated from the aggregated data. Synthesized data may also contain additional voice markup inserted into the text content, which adds additional voice capability.

Alternatively, any of the devices of the system of FIG. 1 described as sources may also support a data management and rendering module according to the present invention. For example, the server (106), as described above, is capable of supporting a data management and rendering module providing uniform access to the data of disparate data types available from the disparate data sources. Any of the devices of FIG. 1, as described above, such as, for example, a PDA, a tablet computer, a cellular phone, or any other device as will occur to those of skill in the art, are capable of supporting a data management and rendering module according to the present invention.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

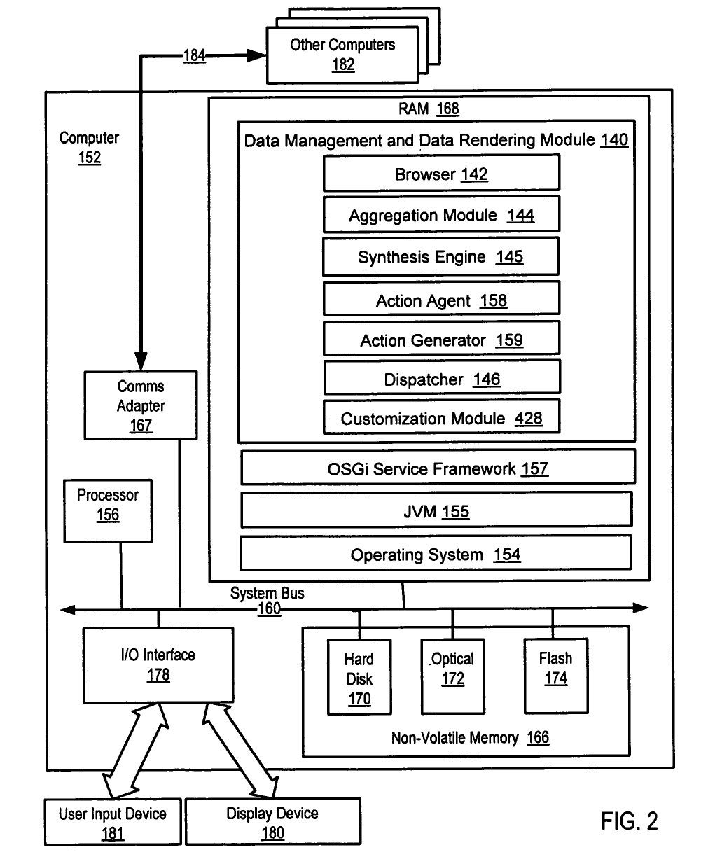

A method for data management and data rendering for disparate data types in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in data management and data rendering for disparate data types according to embodiments of the present invention. The computer (152) of FIG. 2 includes at least one computer processor (156) or ‘CPU’ as well as random access memory (168) (‘RAM’) which is connected through a system bus (160) to a processor (156) and to other components of the computer.

Stored in RAM (168) is a data management and data rendering module (140), computer program instructions for data management and data rendering for disparate data types capable generally of aggregating data of disparate data types from disparate data sources; synthesizing the aggregated data of disparate data types into data of a uniform data type; identifying an action in dependence upon the synthesized data; and executing the identified action. Data management and data rendering for disparate data types advantageously provides to the user the capability to efficiently access and manipulate data gathered from disparate data type-specific resources. Data management and data rendering for disparate data types also provides a uniform data type such that a user may access data gathered from disparate data type-specific resources on a single device.

Also stored in RAM (168) is a customization module (428), a set of computer program instructions for customizing data management and data rendering for data of disparate data types capable generally of receiving aggregation preferences from a user for use in aggregating data of disparate data types from disparate data sources in dependence upon the aggregation preferences and receiving synthesis preferences from a user for use in synthesizing the aggregated data of disparate data types into data of a uniform data type in dependence upon the synthesis preferences. Aggregation preferences are user provided preferences governing aspects of aggregating data of disparate data types. Aggregation preferences include retrieval preferences such as aggregation timing preferences that dictate to an aggregation process times to aggregate data or time periods dictating how often to aggregate data, data source preferences dictating to an aggregation process data sources from which to aggregate data, as well as other aggregation preferences as will occur to those of skill in the art. Synthesis preferences are user provided preferences governing aspects of synthesizing data of disparate data types. Synthesis preferences include preferences for synthesizing data of a particular data type, as well as preferences for other aspects of synthesizing the data such as the volume of data to synthesize, presentation formatting for the synthesized data, prosody preferences for aural presentation of the synthesized data, grammar preferences for synthesizing the data, and other preferences that will occur to those of skill in the art. Prosody preferences are preferences governing distinctive speech characteristics implemented by a voice engine such as variations of stress of syllables, intonation, timing in spoken language, variations in pitch from word to word, the rate of speech, the loudness of speech, the duration of pauses, and other distinctive speech characteristics as will occur to those of skill in the art.

Also stored in RAM (168) is an aggregation module (144), computer program instructions for aggregating data of disparate data types from disparate data sources capable generally of receiving, from an aggregation process, a request for data; identifying, in response to the request for data, one of two or more disparate data sources as a source for data; retrieving, from the identified data source, the requested data; and returning to the aggregation process the requested data. Aggregating data of disparate data types from disparate data sources advantageously provides the capability to collect data from multiple sources for synthesis.

Also stored in RAM is a synthesis engine (145), computer program instructions for synthesizing aggregated data of disparate data types into data of a uniform data type capable generally of receiving aggregated data of disparate data types and translating each of the aggregated data of disparate data types into translated data composed of text content and markup associated with the text content. Synthesizing aggregated data of disparate data types into data of a uniform data type advantageously provides synthesized data of a uniform data type which is capable of being accessed and manipulated by a single device.

Also stored in RAM (168) is an action generator module (159), a set of computer program instructions for identifying actions in dependence upon synthesized data and often user instructions. Identifying an action in dependence upon the synthesized data advantageously provides the capability of interacting with and managing synthesized data.

Also stored in RAM (168) is an action agent (158), a set of computer program instructions for administering the execution of one or more identified actions. Such execution may be executed immediately upon identification, periodically after identification, or scheduled after identification as will occur to those of skill in the art.

Also stored in RAM (168) is a dispatcher (146), computer program instructions for receiving, from an aggregation process, a request for data; identifying, in response to the request for data, one of a plurality of disparate data sources as a source for the data; retrieving, from the identified data source, the requested data; and returning, to the aggregation process, the requested data. Receiving, from an aggregation process, a request for data; identifying, in response to the request for data, one of a plurality of disparate data sources as a source for the data; retrieving, from the identified data source, the requested data; and returning, to the aggregation process, the requested data advantageously provides the capability to access disparate data sources for aggregation and synthesis.

The dispatcher (146) of FIG. 2 also includes a plurality of plug-in modules, computer program instructions for retrieving, from a data source associated with the plug-in, requested data for use by an aggregation process. Such plug-ins isolate the general actions of the dispatcher from the specific requirements needed to retrieve data of a particular type.

Also stored in RAM (168) is a browser (142), computer program instructions for providing an interface for the user to synthesized data. Providing an interface for the user to synthesized data advantageously provides a user access to content of data retrieved from disparate data sources without having to use data source-specific devices. The browser (142) of FIG. 2 is capable of multimodal interaction capable of receiving multimodal input and interacting with users through multimodal output. Such multimodal browsers typically support multimodal web pages that provide multimodal interaction through hierarchical menus that may be speech driven.

Also stored in RAM is an OSGi Service Framework (157) running on a Java Virtual Machine (‘JWM’) (155). “OSGi” refers to the Open Service Gateway initiative, an industry organization developing specifications delivery of service bundles, software middleware providing compliant data communications and services through services gateways. The OSGi specification is a Java based application layer framework that gives service providers, network operator device makers, and appliance manufacturer's vendor neutral application and device layer APIs and functions. OSGi works with a variety of networking technologies like Ethernet, Bluetooth, the ‘Home, Audio and Video Interoperability standard’ (HAVi), IEEE 1394, Universal Serial Bus (USB), WAP, X-10, Lon Works, HomePlug and various other networking technologies. The OSGi specification is available for free download from the OSGi website at www.osgi.org.

An OSGi service framework (157) is written in Java and therefore, typically runs on a Java Virtual Machine (JVM) (155). In OSGi, the service framework (157) is a hosting platform for running ‘services’. The term ‘service’ or ‘services’ in this disclosure, depending on context, generally refers to OSGi-compliant services.

Services are the main building blocks for creating applications according to the OSGi. A service is a group of Java classes and interfaces that implement a certain feature. The OSGi specification provides a number of standard services. For example, OSGi provides a standard HTTP service that creates a web server that can respond to requests from HTTP clients.

OSGi also provides a set of standard services called the Device Access Specification. The Device Access Specification (“DAS”) provides services to identify a device connected to the services gateway, search for a driver for that device, and install the driver for the device.

Services in OSGi are packaged in ‘bundles’ with other files, images, and resources that the services need for execution. A bundle is a Java archive or ‘JAR’ file including one or more service implementations, an activator class, and a manifest file. An activator class is a Java class that the service framework uses to start and stop a bundle. A manifest file is a standard text file that describes the contents of the bundle.

The service framework (157) in OSGi also includes a service registry. The service registry includes a service registration including the service's name and an instance of a class that implements the service for each bundle installed on the framework and registered with the service registry. A bundle may request services that are not included in the bundle, but are registered on the framework service registry. To find a service, a bundle performs a query on the framework's service registry.

Data management and data rendering according to embodiments of the present invention may be usefully invoke one ore more OSGi services. OSGi is included for explanation and not for limitation. In fact, data management and data rendering according to embodiments of the present invention may usefully employ many different technologies an all such technologies are well within the scope of the present invention.

Also stored in RAM (168) is an operating system (154). Operating systems useful in computers according to embodiments of the present invention include UNIX™, Linux™, Microsoft Windows NT™, AIX™, IBM's i5/OS™, and others as will occur to those of skill in the art. The operating system (154) and data management and data rendering module (140) in the example of FIG. 2 are shown in RAM (168), but many components of such software typically are stored in non-volatile memory (166) also.

Computer (152) of FIG. 2 includes non-volatile computer memory (166) coupled through a system bus (160) to a processor (156) and to other components of the computer (152). Non-volatile computer memory (166) may be implemented as a hard disk drive (170), an optical disk drive (172), an electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as a USB, through data communications networks such as IP networks, and in other ways as will occur to those of skill in the art. Communications adapters implement the hardware level of data communications through which one computer sends data communications to another computer, directly or through a network. Examples of communications adapters useful for data management and data rendering according to embodiments of the present invention include modems for wired dial-up communications, Ethernet (IEEE 802.3) adapters for wired network communications, and 802.11b adapters for wireless network communications.

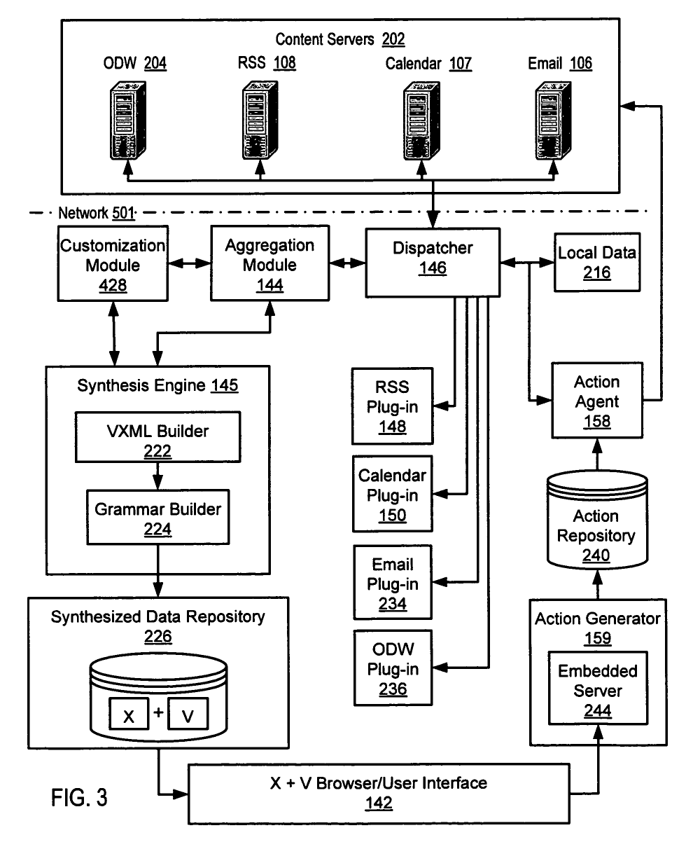

For further explanation, FIG. 3 sets forth a block diagram depicting a system for data management and data rendering for disparate data types according to of the present invention. The system of FIG. 3 includes an aggregation module (144), computer program instructions for aggregating data of disparate data types from disparate data sources capable generally of receiving, from an aggregation process, a request for data; identifying, in response to the request for data, one of two or more disparate data sources as a source for data; retrieving, from the identified data source, the requested data; and returning to the aggregation process the requested data.

The system of FIG. 3 includes a synthesis engine (145), computer program instructions for synthesizing aggregated data of disparate data types into data of a uniform data type capable generally of receiving aggregated data of disparate data types and translating each of the aggregated data of disparate data types into translated data composed of text content and markup associated with the text content.

The synthesis engine (145) includes a VXML Builder (222) module, computer program instructions for translating each of the aggregated data of disparate data types into text content and markup associated with the text content. The synthesis engine (145) also includes a grammar builder (224) module, computer program instructions for generating grammars for voice markup associated with the text content.

The system of FIG. 3 also includes a customization module (428), a set of computer program instructions for customizing data management and data rendering for data of disparate data types capable generally of receiving aggregation preferences from a user for use in aggregating data of disparate data types from disparate data sources in dependence upon the aggregation preferences and receiving synthesis preferences from a user for use in synthesizing the aggregated data of disparate data types into data of a uniform data type in dependence upon the synthesis preferences. Customizing data management and data rendering for data of disparate data types advantageously provides improved access to data based upon the particular user's own preferences.

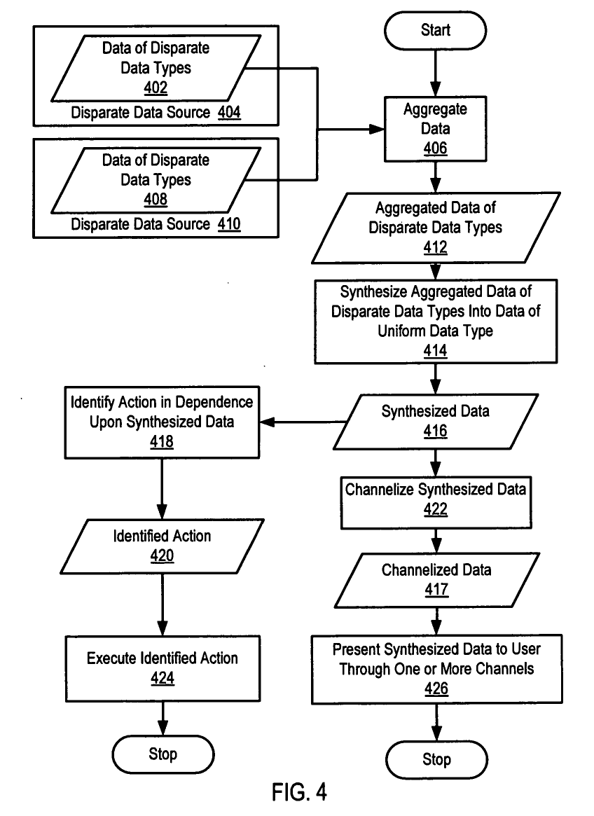

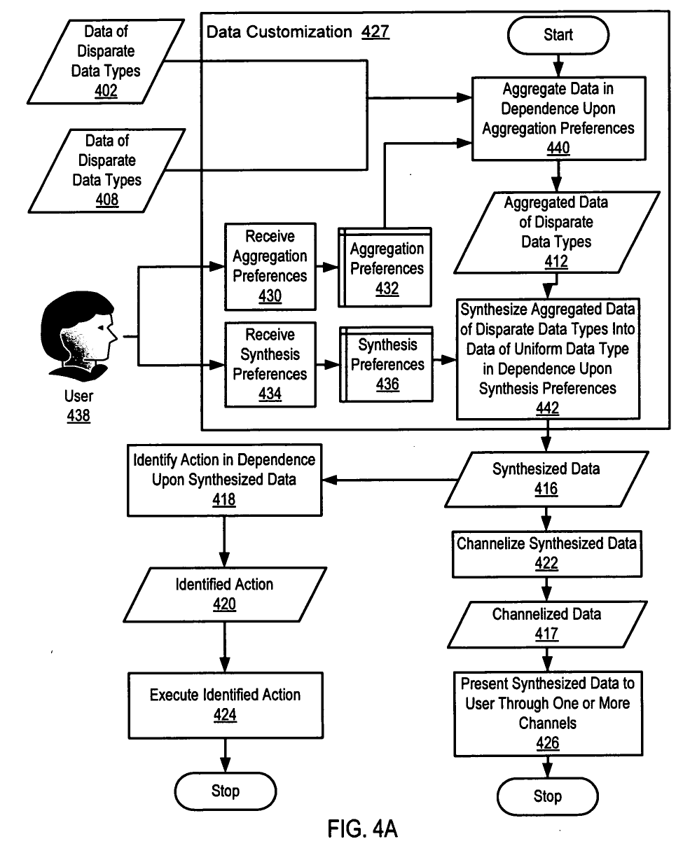

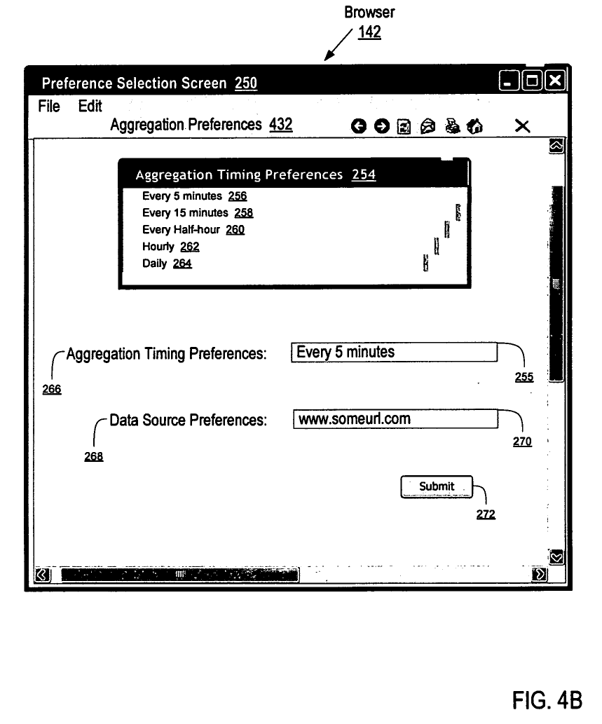

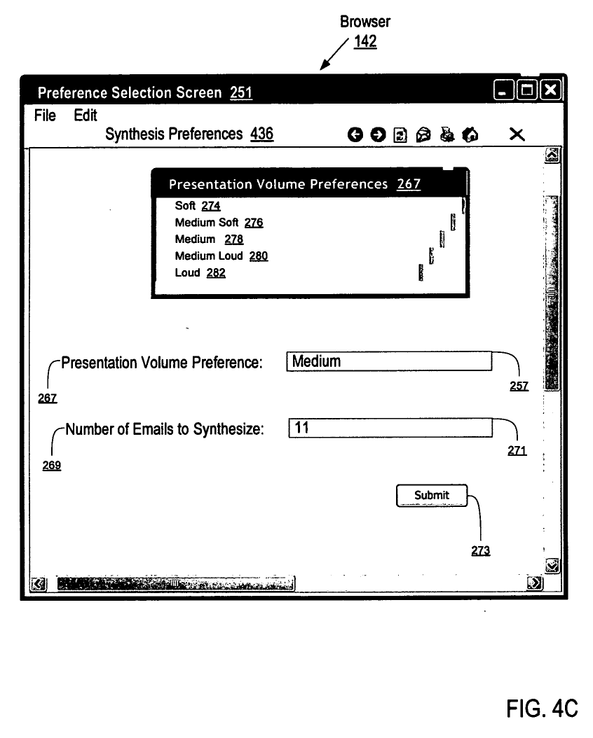

The system of FIG. 3 includes a synthesized data repository (226), data storage for the synthesized data created by the synthesis engine in X+V format. The system of FIG. 3 also includes an X+V browser (142), computer program instructions capable generally of presenting the synthesized data from the synthesized data repository (226) to the user. Presenting the synthesized data may include both graphical display and audio representation of the synthesized data. As discussed below with reference to FIG. 4, one way presenting the synthesized data to a user may be carried out is by presenting synthesized data through one or more channels.

The system of FIG. 3 includes a dispatcher (146) module, computer program instructions for receiving, from an aggregation process, a request for data; identifying, in response to the request for data, one of a plurality of disparate data sources as a source for the data; retrieving, from the identified data source, the requested data; and returning, to the aggregation process, the requested data. The dispatcher (146) module accesses data of disparate data types from disparate data sources for the aggregation module (144), the synthesis engine (145), and the action agent (158). The system of FIG. 3 includes data source-specific plug-ins (148-150, 234-236) used by the dispatcher to access data as discussed below.

In the system of FIG. 3, the data sources include local data (216) and content servers (202). Local data (216) is data contained in memory or registers of the automated computing machinery. In the system of FIG. 3, the data sources also include content servers (202). The content servers (202) are connected to the dispatcher (146) module through a network (501). An RSS server (108) of FIG. 3 is a data source for an RSS feed, which the server delivers in the form of an XML file. RSS is a family of XML file formats for web syndication used by news websites and weblogs. The abbreviation is used to refer to the following standards: Rich Site Summary (RSS 0.91), RDF Site Summary (RSS 0.9, 1.0 and 1.1), and Really Simple Syndication (RSS 2.0). The RSS formats provide web content or summaries of web content together with links to the full versions of the content, and other meta-data. This information is delivered as an XML file called RSS feed, webfeed, RSS stream, or RSS channel.

In the system of FIG. 3, an email server (106) is a data source for email. The server delivers this email in the form of a Lotus NOTES file. In the system of FIG. 3, a calendar server 107 is a data source for calendar information. Calendar information includes calendared events and other related information. The server delivers this calendar information in the form of a Lotus NOTES file.

In the system of FIG. 3, an IBM On Demand Workstation 204 a server providing support for an On Demand Workplace (‘ODW’) that provides productivity tools, and a virtual space to share ideas and expertise, collaborate with others, and find information.

The system of FIG. 3 includes data source-specific plug-ins (148-150, 234-236). For each data source listed above, the dispatcher uses a specific plug-in to access data.

The system of FIG. 3 includes an RSS plug-in (148) associated with an RSS server (108) running an RSS application. The RSS plug-in (148) of FIG. 3 retrieves the RSS feed from the RSS server (108) for the user and provides the RSS feed in an XML file to the aggregation module.

The system of FIG. 3 includes a calendar plug-in (150) associated with a calendar server (107) running a calendaring application. The calendar plug-in (150) of FIG. 3 retrieves calendared events from the calendar server (107) for the user and provides the calendared events to the aggregation module.

The system of FIG. 3 includes an email plug-in (234) associated with an email server (106) running an email application. The email plug-in (234) of FIG. 3 retrieves email from the email server (106) for the user and provides the email to the aggregation module.

The system of FIG. 3 includes an On Demand Workstation (‘ODW’) plug-in (236) associated with an ODW server (204) running an ODW application. The ODW plug-in (236) of FIG. 3 retrieves ODW data from the ODW server (204) for the user and provides the ODW data to the aggregation module.

The system of FIG. 3 also includes an action generator module (159), computer program instructions for identifying an action from the action repository (240) in dependence upon the synthesized data capable generally of receiving a user instruction, selecting synthesized data in response to the user instruction, and selecting an action in dependence upon the user instruction and the selected data.

The action generator module (159) contains an embedded server (244). The embedded server (244) receives user instructions through the X+V browser (142). Upon identifying an action from the action repository (240), the action generator module (159) employs the action agent (158) to execute the action. The system of FIG. 3 includes an action agent (158), computer program instructions for executing an action capable generally of executing actions.

For further explanation, FIG. 4 sets forth a flow chart illustrating an exemplary method for data management and data rendering for disparate data types according to embodiments of the present invention. The method of FIG. 4 includes aggregating (406) data of disparate data types (402, 408) from disparate data sources (404, 410). As discussed above, aggregated data of disparate data types is the accumulation, in a single location, of data of disparate types. This location of the aggregated data may be either physical, such as, for example, on a single computer containing aggregated data, or logical, such as, for example, a single interface providing access to the aggregated data.

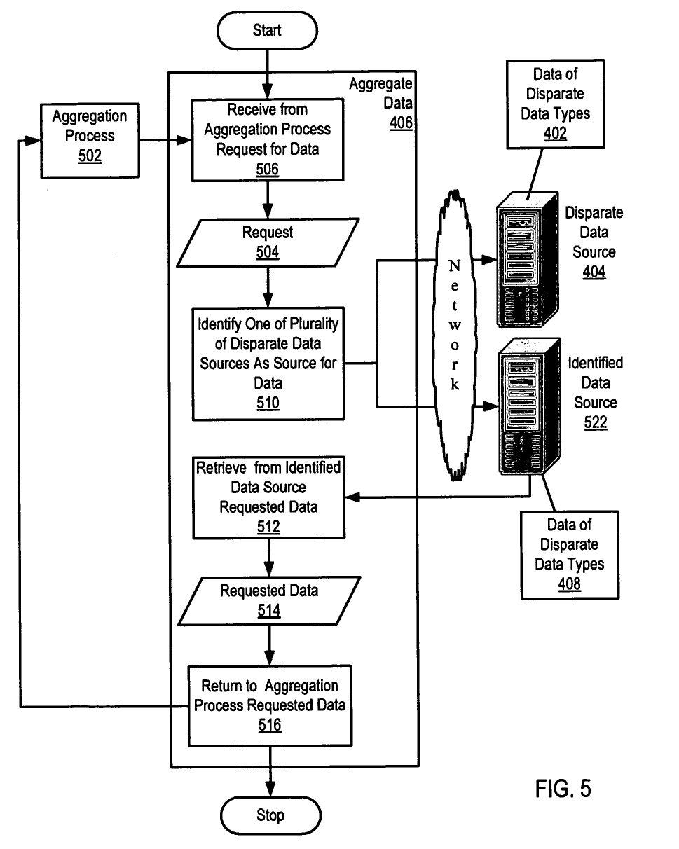

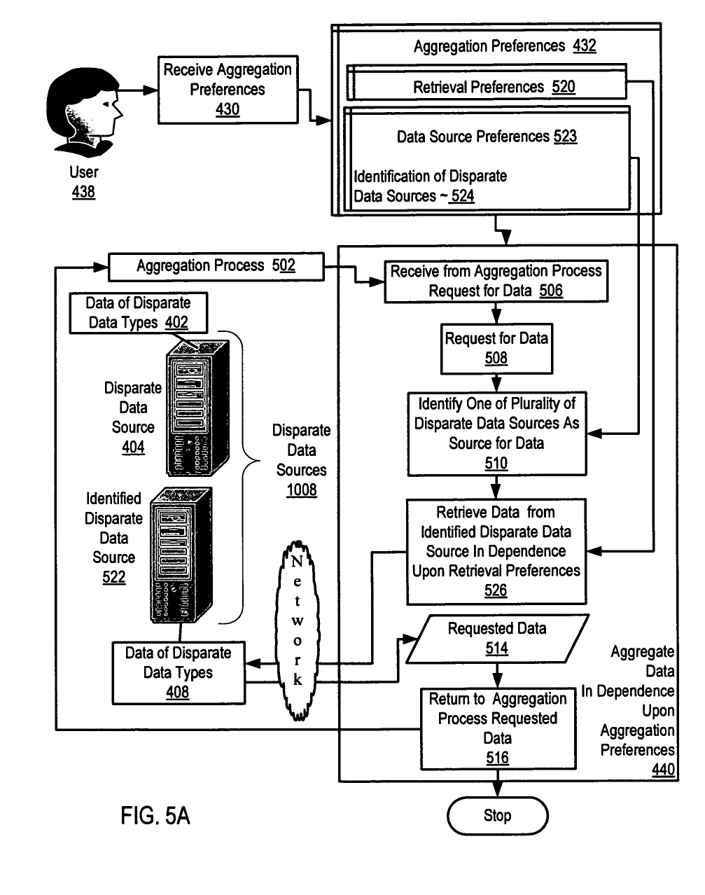

Aggregating (406) data of disparate data types (402, 408) from disparate data sources (404, 410) according to the method of FIG. 4 may be carried out by receiving, from an aggregation process, a request for data; identifying, in response to the request for data, one of two or more disparate data sources as a source for data; retrieving, from the identified data source, the requested data; and returning to the aggregation process the requested data as discussed in more detail below with reference to FIG. 5.

The method of FIG. 4 also includes synthesizing (414) the aggregated data of disparate data types (412) into data of a uniform data type. Data of a uniform data type is data having been created or translated into a format of predetermined type. That is, uniform data types are data of a single kind that may be rendered on a device capable of rendering data of the uniform data type. Synthesizing (414) the aggregated data of disparate data types (412) into data of a uniform data type advantageously results in a single point of access for the content of the aggregation of disparate data retrieved from disparate data sources.

One example of a uniform data type useful in synthesizing (414) aggregated data of disparate data types (412) into data of a uniform data type is XHTML plus Voice. XHTML plus Voice (‘X+V’) is a Web markup language for developing multimodal applications, by enabling voice in a presentation layer with voice markup. X+V provides voice-based interaction in small and mobile devices using both voice and visual elements. X+V is composed of three main standards: XHTML, VoiceXML, and XML Events. Given that the Web application environment is event-driven, X+V incorporates the Document Object Model (DOM) eventing framework used in the XML Events standard. Using this framework, X+V defines the familiar event types from HTML to create the correlation between visual and voice markup.

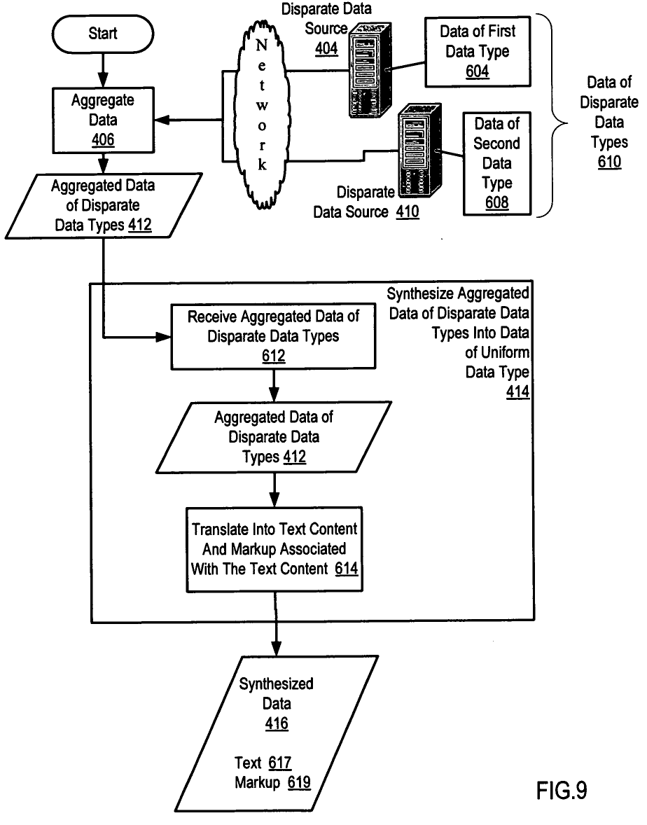

Synthesizing (414) the aggregated data of disparate data types (412) into data of a uniform data type may be carried out by receiving aggregated data of disparate data types and translating each of the aggregated data of disparate data types into text content and markup associated with the text content as discussed in more detail with reference to FIG. 9. In the method of FIG. 4, synthesizing the aggregated data of disparate data types (412) into data of a uniform data type may be carried out by translating the aggregated data into X+V, or any other markup language as will occur to those of skill in the art.

The method for data management and data rendering of FIG. 4 also includes identifying (418) an action in dependence upon the synthesized data (416). An action is a set of computer instructions that when executed carry out a predefined task. The action may be executed in dependence upon the synthesized data immediately or at some defined later time. Identifying (418) an action in dependence upon the synthesized data (416) may be carried out by receiving a user instruction, selecting synthesized data in response to the user instruction, and selecting an action in dependence upon the user instruction and the selected data.

A user instruction is an event received in response to an act by a user. Exemplary user instructions include receiving events as a result of a user entering a combination of keystrokes using a keyboard or keypad, receiving speech from a user, receiving an event as a result of clicking on icons on a visual display by using a mouse, receiving an event as a result of a user pressing an icon on a touchpad, or other user instructions as will occur to those of skill in the art. Receiving a user instruction may be carried out by receiving speech from a user, converting the speech to text, and determining in dependence upon the text and a grammar the user instruction. Alternatively, receiving a user instruction may be carried out by receiving speech from a user and determining the user instruction in dependence upon the speech and a grammar.

The method of FIG. 4 also includes executing (424) the identified action (420). Executing (424) the identified action (420) may be carried out by calling a member method in an action object identified in dependence upon the synthesized data, executing computer program instructions carrying out the identified action, as well as other ways of executing an identified action as will occur to those of skill in the art. Executing (424) the identified action (420) may also include determining the availability of a communications network required to carry out the action and executing the action only if the communications network is available and postponing executing the action if the communications network connection is not available. Postponing executing the action if the communications network connection is not available may include enqueuing identified actions into an action queue, storing the actions until a communications network is available, and then executing the identified actions. Another way that waiting to execute the identified action (420) may be carried out is by inserting an entry delineating the action into a container, and later processing the container. A container could be any data structure suitable for storing an entry delineating an action, such as, for example, an XML file.

Executing (424) the identified action (420) may include modifying the content of data of one of the disparate data sources. Consider for example, an action called deleteOldEmail( ) that when executed deletes not only synthesized data translated from email, but also deletes the original source email stored on an email server coupled for data communications with a data management and data rendering module operating according to the present invention.

The method of FIG. 4 also includes channelizing (422) the synthesized data (416). A channel is a logical aggregation of data content for presentation to a user. Channelizing (422) the synthesized data (416) may be carried out by identifying attributes of the synthesized data, characterizing the attributes of the synthesized data, and assigning the data to a predetermined channel in dependence upon the characterized attributes and channel assignment rules. Channelizing the synthesized data advantageously provides a vehicle for presenting related content to a user. Examples of such channelized data may be a ‘work channel’ that provides a channel of work related content, an ‘entertainment channel’ that provides a channel of entertainment content an so on as will occur to those of skill in the art.

The method of FIG. 4 may also include presenting (426) the synthesized data (416) to a user through one or more channels. One way presenting (426) the synthesized data (416) to a user through one or more channels may be carried out is by presenting summaries or headings of available channels. The content presented through those channels can be accessed via this presentation in order to access the synthesized data (416). Another way presenting (426) the synthesized data (416) to a user through one or more channels may be carried out by displaying or playing the synthesized data (416) contained in the channel. Text data may be displayed visually, or translated for aural presentation to the user.

As discussed above, data management and data rendering for data of disparate data may be further customized by receiving aggregation preferences from a user for use in aggregating data of disparate data types from disparate data sources in dependence upon the aggregation preferences and receiving synthesis preferences from a user for use in synthesizing the aggregated data of disparate data types into data of a uniform data type in dependence upon the synthesis preferences. Customizing data management and data rendering for data of disparate data types advantageously provides improved access to data based upon the particular user's own preferences.

For further explanation, FIG. 4A sets forth a flow chart illustrating an exemplary method for data management and data rendering for disparate data types according to embodiments of the present invention that also includes data customization (427) for data of disparate data types (402, 408). As discussed above, disparate data types are data of different kind and form. That is, disparate data types are data of different kinds. The distinctions in data that define the disparate data types may include a difference in data structure, file format, protocol in which the data is transmitted, and other distinctions as will occur to those of skill in the art.

In the method of FIG. 4A data customization (427) for data of disparate data types (402, 408) includes receiving (430) aggregation preferences (432) from a user (438). Aggregation preferences (432) are user provided preferences governing aspects of aggregating data of disparate data types. Examples of aggregation preferences include aggregation timing preferences that dictate to an aggregation process times to aggregate data or time periods dictating how often to aggregate data, data source preferences dictating to an aggregation process data sources from which to aggregate data, as well as other aggregation preferences as will occur to those of skill in the art.

Receiving (430) aggregation preferences (432) from a user (438) may be carried out by receiving from the user a user instruction selecting predefined aggregation preferences and storing the aggregation preferences selected by the user in a configurations file. Such stored aggregation preferences in a configurations file is available for use in aggregating data of disparate data types from disparate data sources in dependence upon the aggregation preferences. Examples of predefined aggregation preferences may include retrieval preferences such as aggregation timing preferences dictating to an aggregation process times to aggregate data or dictating to an aggregation process period timing requirements defining how often data is aggregated. To select predefined aggregation preferences users may access aggregation preference selections screens through for example a browser in a data management and data rendering module. Aggregation preference selection screens are typically capable of receiving user instructions for selecting predefined aggregation preferences by providing a list of predefined aggregation preferences and receiving a user instruction selecting one of the presented preferences.

Receiving (430) aggregation preferences (432) from a user (438) may also be carried out by receiving from the user a user instruction identifying an aggregation preferences that is not predefined and storing the aggregation preferences selected by the user in a configurations file. An example of an aggregation preference that is not predefined includes data source preferences dictating to an aggregation process data sources from which to aggregate data. Aggregation preferences stored in a configurations file are available for use in aggregating data of disparate data types from disparate data sources in dependence upon the aggregation preferences. To select aggregation preferences that are not predefined users may access aggregation preference selection screens through, for example, a browser in a data management and data rendering module. Aggregation preference selection screens are typically capable of receiving user instructions for selecting aggregation preferences that are not defined by providing, for example, a GUI input box for receiving a user instruction.

For further explanation, FIG. 4B sets forth a line drawing of a browser (142) in a data management and data rendering module operating in accordance with the method of FIG. 4A and displaying a preference selection screen (250). The preference selection screen (250) of FIG. 4B designed to receive aggregation preferences (432) from a user. As discussed above, receiving aggregation preferences (432) from a user may be carried out by receiving from the user a user instruction selecting predefined aggregation preferences. The exemplary preference selection screen (250) includes an input widget (254) displaying predefined menu choices (256-264) for an aggregation timing preference (254), which is one of the available aggregation preferences (432). The input widget of FIG. 4B is a GUI widget that accepts inputs through a user's mouse click on one of the predefined aggregation timing preferences displayed in the menu (254). The predefined menu choices for the displayed aggregation timing preference (254) includes aggregating: ‘every 5 minutes’ (256), ‘every 15 minutes’ (258), ‘every half-hour’ (260), ‘hourly’ (262), or ‘daily’ (264). The exemplary preference selection screen (250) of FIG. 4B also displays text describing the selected aggregation timing preference (254) in a text box (255). In this example, a user has selected an aggregation timing preference (254) of every 5 minutes (256).

As discussed above, receiving aggregation preferences (432) from a user may also be carried out by receiving from the user a user instruction identifying an aggregation preference that is not predefined. The exemplary preference selection screen (250) also has a GUI input box (270) for receiving, from a user, a user instruction identifying a data source preference (268), which, in the preference selection screen (250) of FIG. 4B, is an aggregation preference that is not predefined. The exemplary preference selection screen (250) also displays the text of the user instruction received through the GUI input box (270) describing the data source preference (268). In this example, a user has selected a data source preference (268) of www.someurl.com. The exemplary preference selection screen (250) also has a button (272) which accepts a user instruction through a mouse click to submit selected aggregation preferences (432) from a user to a data management and data rendering module for storage in a user configurations file.

Again with reference to FIG. 4A: Data customization for data of disparate data types (402, 408) also includes receiving (434) synthesis preferences (436) from a user (438). Synthesis preferences (436) are user provided preferences governing aspects of synthesizing data of disparate data types. Synthesis preferences include preferences for synthesizing data of a particular data type, as well as preferences for other aspects of synthesizing the data such as the volume of data to synthesize, presentation formatting for the synthesized data, prosody preferences for aural presentation of the synthesized data, grammar preferences for synthesizing the data, and other preferences that will occur to those of skill in the art. Prosody preferences are preferences governing distinctive speech characteristics implemented by a voice engine such as variations of stress of syllables, intonation, timing in spoken language, variations in pitch from word to word, the rate of speech, the loudness of speech, the duration of pauses, and other distinctive speech characteristics as will occur to those of skill in the art.

Receiving (434) synthesis preferences (436) from a user (438) may be carried out by receiving from the user a user instruction selecting predefined synthesis preferences and storing the synthesis preferences selected by the user in a configurations file. Such stored synthesis preferences in a configurations file are available for use in synthesizing data of disparate data types from disparate data sources in dependence upon the synthesis preferences. Examples of predefined synthesis preferences include preferences for synthesizing data of a particular data type, presentation formatting for the synthesized data, prosody preferences for aural presentation of the synthesized data and others as will occur to those of skill in the art. For further explanation consider an example of synthesizing email. Email data may be synthesized according to a predefined synthesis preference to be presented orally with the use of a female voice that reads first who the email is from followed by the date and time that the email arrived followed by the content of the email message. To select predefined synthesis preferences users may access synthesis preference selection screens through for example a browser in a data management and data rendering module. Synthesis preference selection screens are typically capable of receiving user instructions for selecting predefined synthesis preferences by providing a list of predefined synthesis preferences and receiving a user instruction selecting one of the presented preferences.

Receiving (434) synthesis preferences (436) from a user (438) may also be carried out by receiving from the user a user instruction identifying synthesis preferences that are not predefined and storing the synthesis preferences selected by the user in a configurations file. Examples of synthesis preferences that may not be predefined include volume preferences indicating the volume of data to synthesize and grammar preferences indicating specific words for inclusion in grammars associated with the synthesized data. Synthesis preferences stored in a configurations file are available for use in synthesizing data of disparate data types from disparate data sources in dependence upon the synthesis preferences. To select synthesis preferences that are not predefined users may access synthesis preference selection screens through, for example, a browser in a data management and data rendering module. Synthesis preference selection screens are typically capable of receiving user instructions for selecting synthesis preferences that are not defined by providing, for example, a GUI input box for receiving a user instruction.

For further explanation, FIG. 4C sets forth a line drawing of a browser (142) in a data management and data rendering module operating in accordance with the method of FIG. 4A and displaying a preference selection screen (251). The preference selection screen (251) of FIG. 4C is designed to receive synthesis preferences (436) from a user. As discussed above, receiving synthesis preferences (436) from a user may be carried out by receiving from the user a user instruction selecting predefined aggregation preferences. The exemplary preference selection screen (251) includes an input widget (267) displaying predefined menu choices for presentation volume preferences (274-282) defining the volume at which a voice engine presents the synthesized data to a user. The input widget of FIG. 4C is a GUI widget that accepts a user selection of one of the displayed presentation volume preferences through a mouse click on the display of the selected presentation volume preference inputs. The menu choices include the volumes of ‘soft’ (274), ‘medium soft’ (276), ‘medium’ (278), ‘medium loud’ (280), or ‘loud’ (282). The exemplary preference selection screen (251) also displays text describing the presentation volume preferences (267) in a text box (257). In this example, a user has selected a presentation volume preference (267) of medium (278).

As discussed above, receiving synthesis preferences (436) from a user may also be carried out by receiving from the user a user instruction identifying an aggregation preference that is not predefined. The exemplary preference selection screen (251) also has a GUI input box (271) for receiving from a user a user instruction identifying a number of emails to synthesize (269) preference, which, in the preference selection screen (251) of FIG. 4C, is a synthesis preference that is not predefined. The exemplary preference selection screen (251) also displays in a text box (271) the text of the user instruction describing the user's preference for the number of emails to synthesize (269). In this example, a user has selected 11 as the number of emails to synthesize (269). The exemplary preference selection screen (251) also has a button (273), labeled ‘submit’, which receives a user instruction through a mouse click to submit selected synthesis preferences (436) to a data management and data rendering module for storage in a configurations file.

Again with reference to FIG. 4A: Data customization for data of disparate data types (402, 408) according to the method of FIG. 4A includes aggregating (440) data of disparate data types (402, 408) from disparate data sources in dependence upon the aggregation preferences (432). As discussed above, aggregated data of disparate data types is the accumulation, in a single location, of data of disparate types. This location of the aggregated data may be either physical, such as, for example, on a single computer containing aggregated data, or logical, such as, for example, a single interface providing access to the aggregated data.

Aggregating (440) data of disparate data types (402, 408) from disparate data sources in dependence upon the aggregation preferences (432) according to the method of FIG. 4 may be carried out by receiving, from an aggregation process, a request for data; identifying, in response to the request for data, one of two or more disparate data sources as a source for data; retrieving user preferences; and retrieving, from the identified data source, the requested data in accordance with the user preferences; and returning to the aggregation process the requested data as discussed in more detail below with reference to FIG. 5.

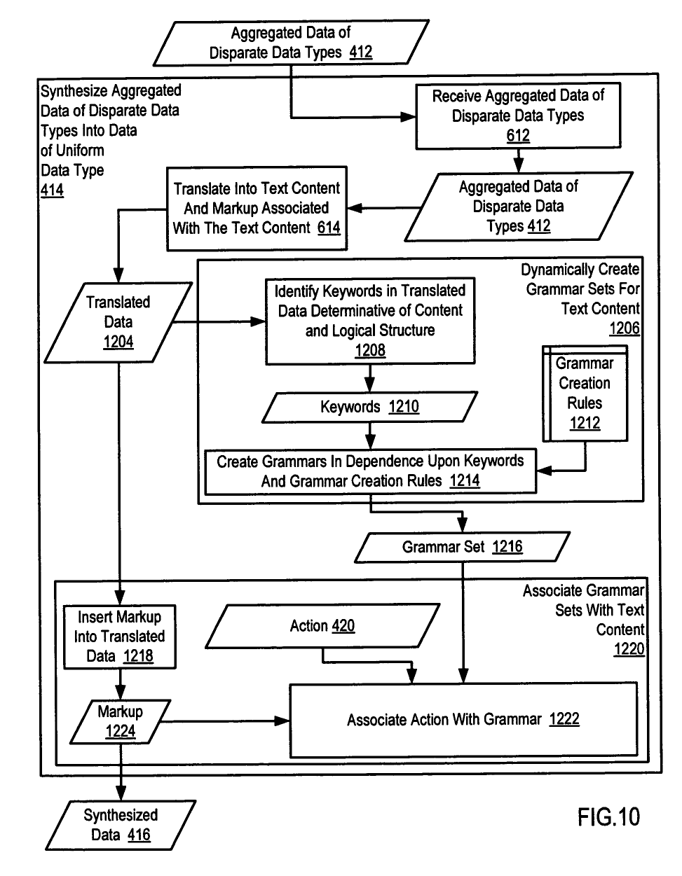

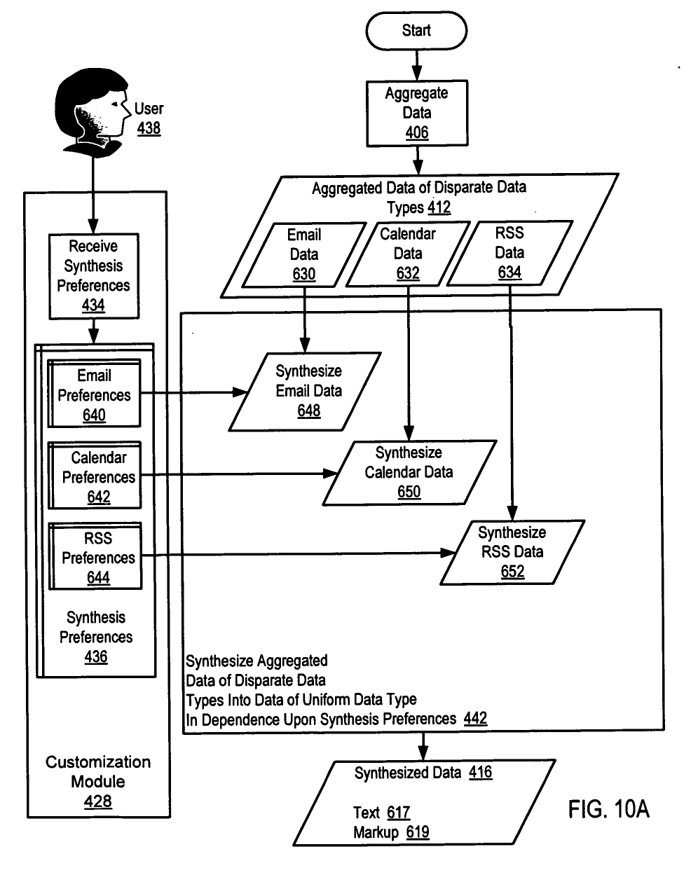

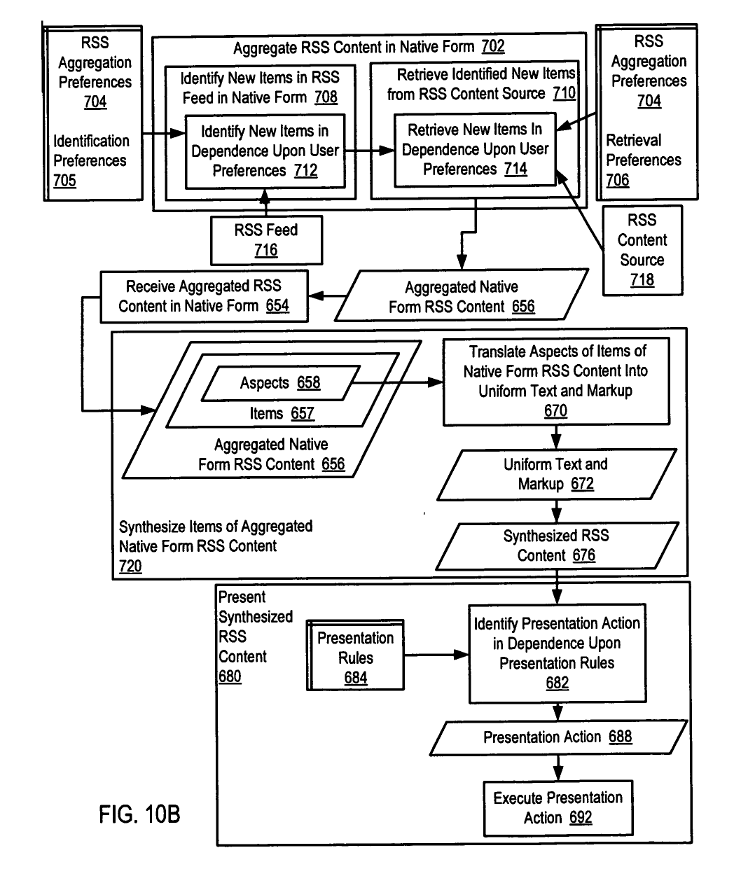

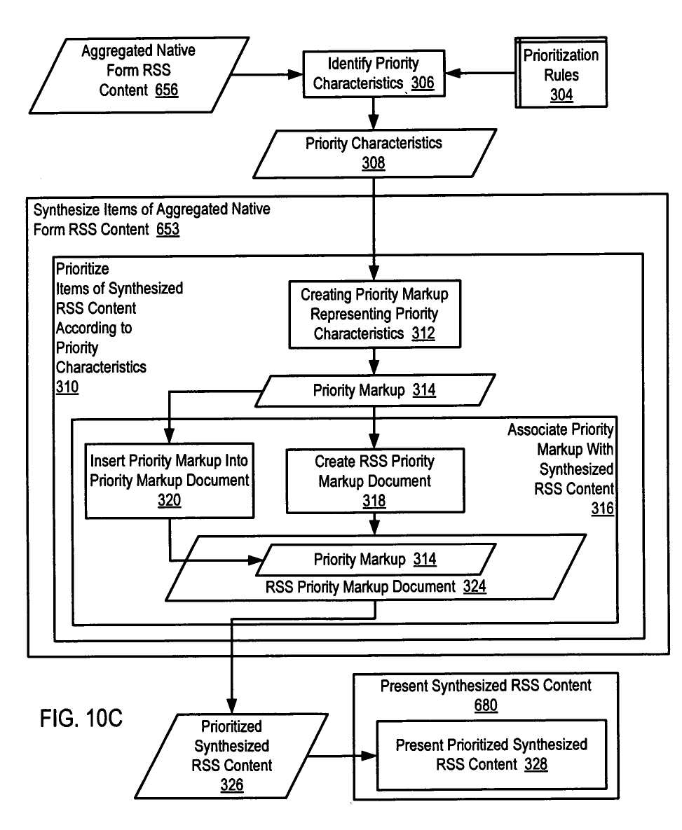

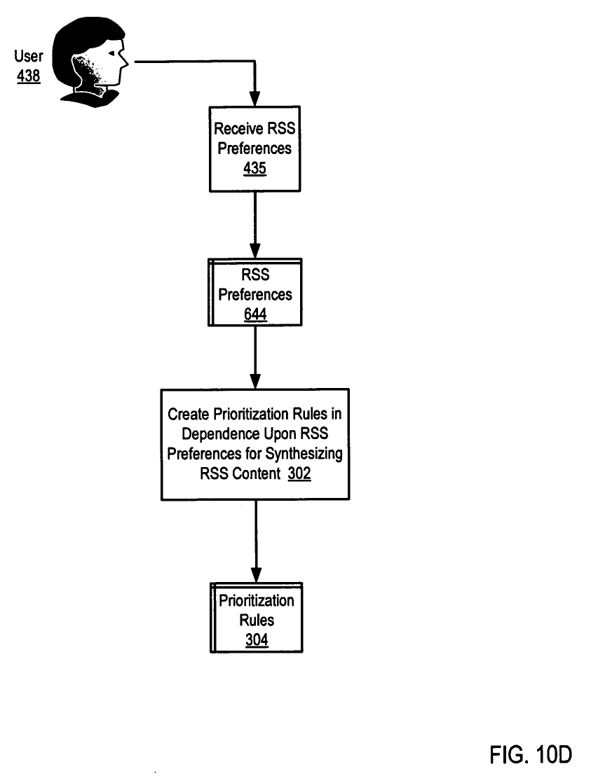

Data customization for data of disparate data types (402, 408) according to the method of FIG. 4A includes synthesizing (442) the aggregated data of disparate data types (412) into data of a uniform data type in dependence upon the synthesis preferences (436). Data of a uniform data type is data having been created or translated into a format of predetermined type. That is, uniform data types are data of a single kind that may be rendered on a device capable of rendering data of the uniform data type. Synthesizing (442) the aggregated data of disparate data types (412) into data of a uniform data type in dependence upon the synthesis preferences (436) may be carried out by receiving aggregated data of disparate data types, retrieving synthesis preferences, and translating each of the aggregated data of disparate data types into text content and markup associated with the text content in dependence upon the synthesis preferences as discussed in more detail with reference to FIG. 10A.

For further explanation, FIG. 5 sets forth a flow chart illustrating an exemplary method for aggregating data of disparate data types from disparate data sources according to embodiments of the present invention. In the method of FIG. 5, aggregating (406) data of disparate data types (402, 408) from disparate data sources (404, 522) includes receiving (506), from an aggregation process (502), a request (504) for data. A request for data may be implemented as a message, from the aggregation process, to a dispatcher instructing the dispatcher to initiate retrieving the requested data and returning the requested data to the aggregation process.

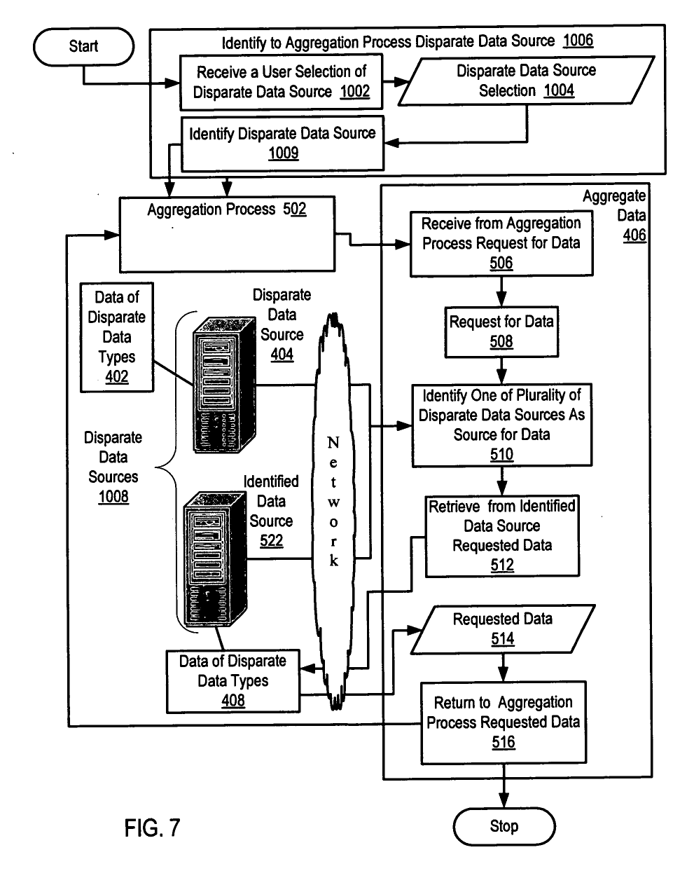

In the method of FIG. 5, aggregating (406) data of disparate data types (402, 408) from disparate data sources (404, 522) also includes identifying (510), in response to the request (504) for data, one of a plurality of disparate data sources (404, 522) as a source for the data. Identifying (510), in response to the request (504) for data, one of a plurality of disparate data sources (404, 522) as a source for the data may be carried out in a number of ways. One way of identifying (510) one of a plurality of disparate data sources (402, 522) as a source for the data may be carried out by receiving, from a user, an identification of the disparate data source; and identifying, to the aggregation process, the disparate data source in dependence upon the identification as discussed in more detail below with reference to FIG. 7.

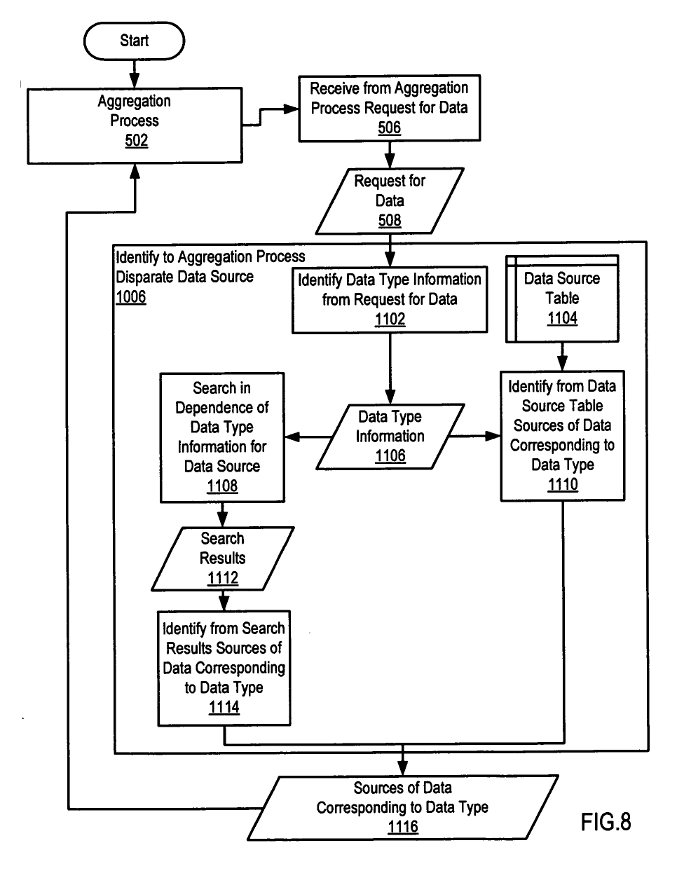

Another way of identifying, to the aggregation process (502), disparate data sources is carried out by identifying, from the request for data, data type information and identifying from the data source table sources of data that correspond to the data type as discussed in more detail below with reference to FIG. 8. Still another way of identifying one of a plurality of data sources is carried out by identifying, from the request for data, data type information; searching, in dependence upon the data type information, for a data source; and identifying from the search results returned in the data source search, sources of data corresponding to the data type also discussed below in more detail with reference to FIG. 8.

The three methods for identifying one of a plurality of data sources described in this specification are for explanation and not for limitation. In fact, there are many ways of identifying one of a plurality of data sources and all such ways are well within the scope of the present invention.

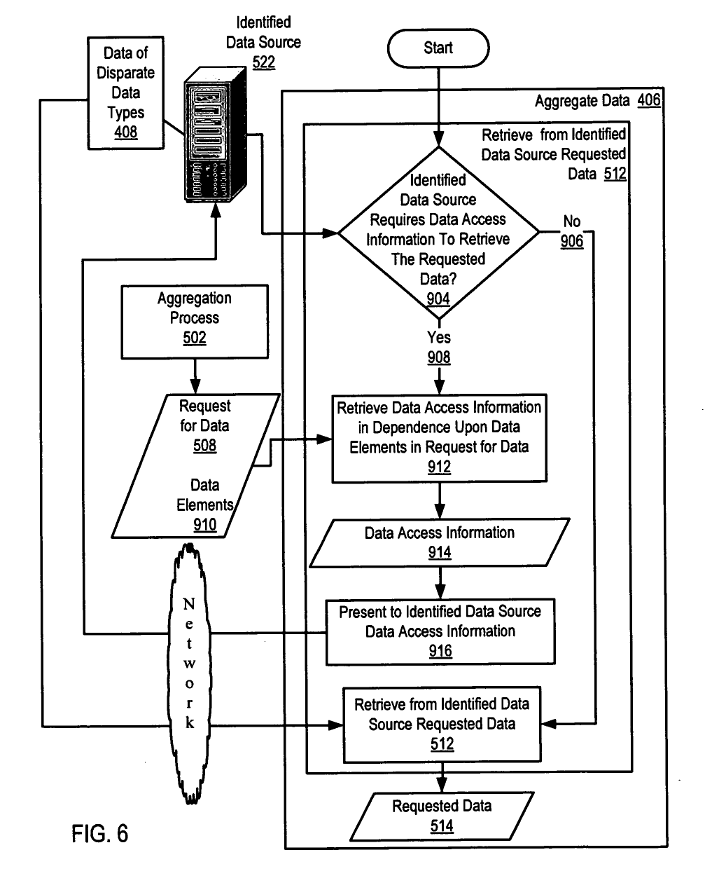

The method for aggregating (406) data of FIG. 5 includes retrieving (512), from the identified data source (522), the requested data (514). Retrieving (512), from the identified data source (522), the requested data (514) includes determining whether the identified data source requires data access information to retrieve the requested data; retrieving, in dependence upon data elements contained in the request for data, the data access information if the identified data source requires data access information to retrieve the requested data; and presenting the data access information to the identified data source as discussed in more detail below with reference to FIG. 6. Retrieving (512) the requested data according the method of FIG. 5 may be carried out by retrieving the data from memory locally, downloading the data from a network location, or any other way of retrieving the requested data that will occur to those of skill in the art. As discussed above, retrieving (512), from the identified data source (522), the requested data (514) may be carried out by a data-source-specific plug-in designed to retrieve data from a particular data source or a particular type of data source.

In the method of FIG. 5, aggregating (406) data of disparate data types (402, 408) from disparate data sources (402, 522) also includes returning (516), to the aggregation process (502), the requested data (514). Returning (516), to the aggregation process (502), the requested data (514) returning the requested data to the aggregation process in a message, storing the data locally and returning a pointer pointing to the location of the stored data to the aggregation process, or any other way of returning the requested data that will occur to those of skill in the art.

As discussed above, aggregation preferences are user provided preferences governing aspects of aggregating data of disparate data types. Aggregation preferences are useful in customization for data of disparate data types according to embodiments of the present invention. For further explanation therefore, FIG. 5A sets forth a flow chart illustrating an exemplary method for aggregating data of disparate data types from disparate data sources in dependence upon the aggregation preferences according to embodiments of the present invention that includes receiving (430) aggregation preferences (432). As discussed above, aggregation preferences (432) are user provided preferences governing aspects of aggregating data of disparate data types. Examples of aggregation preferences include retrieval preferences such as aggregation timing preferences that dictate to an aggregation process times to aggregate data or time periods dictating how often to aggregate data, data source preferences dictating to an aggregation process data sources from which to aggregate data, as well as other aggregation preferences as will occur to those of skill in the art.

The exemplary aggregation preferences (432) of FIG. 5A include retrieval preferences (520). Retrieval preferences (520) are user defined preferences governing retrieval of data from an identified data source. Such retrieval preferences may include aggregation timing preferences that dictate times to aggregate data or time periods defining how often to aggregate data. Retrieval preferences may also include other preferences such as triggering preferences dictating to an aggregation process to aggregate data upon a triggering event such as an event identifying network connectivity, an event identifying the opening or closing of a data management and data rendering module, and other triggering events that will occur to those of skill in the art.

The exemplary aggregation preferences (432) of FIG. 5A also include a data source preferences (523). Data source preferences are preferences identifying user selected sources of data for aggregation and synthesis according to embodiments of the present invention. Examples of data source preferences identifying user selected sources of data may include specific data source identified by a user, such as a URL pointing to a specific news RSS source. The exemplary aggregation preferences (432) of FIG. 5A include an identifications of disparate data sources (524).

Data source preferences identifying user selected sources of data may also include a data source type identified by a user, such as the type ‘news RSS source’; and other preferences as will occur to those of skill in the art. Data source preferences identifying user selected sources of data may also data type preferences identifying a particular type of data to be retrieved from an available source. Such data types identify the kind and form of data to be retrieved. Data types may include data types according to data structure, file format, protocol in which the data is transmitted, and other distinctions as will occur to those of skill in the art.

The three exemplary data source preferences of specific data sources, types of data sources and type of data are of explanation and not for limitation. In fact, those of skill in the art may identify other data source preferences and all such data source preferences are within the scope of the present invention.

In the method of FIG. 5A, aggregating (406) data of disparate data types (402, 408) from disparate data sources (402, 522) includes receiving (506), from an aggregation process (502), a request for data (508). A request for data may be implemented as a message, from the aggregation process, to a dispatcher instructing the dispatcher to initiate retrieving the requested data and returning the requested data to the aggregation process.

In the method of FIG. 5A, aggregating (440) data of disparate data types (402, 408) from disparate data sources in dependence upon the aggregation preferences (432) also includes identifying (510), in response to the request for data (508), one of a plurality of disparate data sources (402, 522) as a source for the data. In the method of FIG. 5A, identifying (510), in response to the request for data (508), one of a plurality of disparate data sources (402, 522) as a source for the data is carried out by retrieving from the data source preferences (523) an identification of a disparate data source responsive to the request for data.

The method for aggregating (440) data of disparate data types (402, 408) from disparate data sources (1008) in dependence upon aggregation preferences (432) of FIG. 5A also includes retrieving 526 data from the identified disparate data source (522) in dependence upon the retrieval preferences (520). Retrieval preferences (520) are user defined preferences governing retrieval of data from an identified data source. Such retrieval preferences may include aggregation timing preferences that dictate to an aggregation process times to aggregate data or time periods dictating how often to aggregate data. Retrieval preferences may also include other preferences such as triggering preferences dictating to an aggregation process to aggregate data upon a triggering event such as an event identifying network connectivity, an event identifying the opening or closing of a data management and data rendering module, and other triggering events that will occur to those of skill in the art. Retrieving (526) data from the identified disparate data source (524) in dependence upon the retrieval preferences (520) therefore may be carried out by retrieving data from the identified disparate data source periodically according to retrieval preferences (520) governing how often to retrieve data, retrieving data from the identified disparate data source for a length of time governed by retrieval preferences (520), retrieving data from the identified disparate data source upon receiving a triggering event in the retrieval preferences, and so on as will occur to those of skill in the art.

In the method of FIG. 5A, aggregating (440) data of disparate data types (402, 408) from disparate data sources in dependence upon the aggregation preferences (432) also includes returning (516), to the aggregation process (502), the requested data (514). Returning (516), to the aggregation process (502), the requested data (514) may be carried out by returning the requested data to the aggregation process in a message, storing the data locally and returning a pointer pointing to the location of the stored data to the aggregation process, or any other way of returning the requested data that will occur to those of skill in the art.

As discussed above with reference to FIG. 5, aggregating data includes retrieving, from the identified data source, the requested data. For further explanation, therefore, FIG. 6 sets forth a flow chart illustrating an exemplary method for retrieving (512), from the identified data source (522), the requested data (514) according to embodiments of the present invention. In the method of FIG. 6, retrieving (512), from the identified data source (522), the requested data (514) includes determining (904) whether the identified data source (522) requires data access information (914) to retrieve the requested data (514). As discussed above in reference to FIG. 5, data access information is information which is required to access some types of data from some of the disparate sources of data. Exemplary data access information includes account names, account numbers, passwords, or any other data access information that will occur to those of skill in the art.

Determining (904) whether the identified data source (522) requires data access information (914) to retrieve the requested data (514) may be carried out by attempting to retrieve data from the identified data source and receiving from the data source a prompt for data access information required to retrieve the data. Alternatively, instead of receiving a prompt from the data source each time data is retrieved from the data source, determining (904) whether the identified data source (522) requires data access information (914) to retrieve the requested data (514) may be carried out once by, for example a user, and provided to a dispatcher such that the required data access information may be provided to a data source with any request for data without prompt. Such data access information may be stored in, for example, a data source table identifying any corresponding data access information needed to access data from the identified data source.

In the method of FIG. 6, retrieving (512), from the identified data source (522), the requested data (514) also includes retrieving (912), in dependence upon data elements (910) contained in the request for data (508), the data access information (914), if the identified data source requires data access information to retrieve the requested data (908). Data elements (910) contained in the request for data (508) are typically values of attributes of the request for data (508). Such values may include values identifying the type of data to be accessed, values identifying the location of the disparate data source for the requested data, or any other values of attributes of the request for data.

Such data elements (910) contained in the request for data (508) are useful in retrieving data access information required to retrieve data from the disparate data source. Data access information needed to access data sources for a user may be usefully stored in a record associated with the user indexed by the data elements found in all requests for data from the data source. Retrieving (912), in dependence upon data elements (910) contained in the request for data (508), the data access information (914) according to FIG. 6 may therefore be carried out by retrieving, from a database in dependence upon one or more data elements in the request, a record containing the data access information and extracting from the record the data access information. Such data access information may be provided to the data source to retrieve the data.

Retrieving (912), in dependence upon data elements (910) contained in the request for data (508), the data access information (914), if the identified data source requires data access information (914) to retrieve the requested data (908), may be carried out by identifying data elements (910) contained in the request for data (508), parsing the data elements to identify data access information (914) needed to retrieve the requested data (908), identifying in a data access table the correct data access information, and retrieving the data access information (914).

The exemplary method of FIG. 6 for retrieving (512), from the identified data source (522), the requested data (514) also includes presenting (916) the data access information (914) to the identified data source (522). Presenting (916) the data access information (914) to the identified data source (522) according to the method of FIG. 6 may be carried out by providing in the request the data access information as parameters to the request or providing the data access information in response to a prompt for such data access information by a data source. That is, presenting (916) the data access information (914) to the identified data source (522) may be carried out by a selected data source specific plug-in of a dispatcher that provides data access information (914) for the identified data source (522) in response to a prompt for such data access information. Alternatively, presenting (916) the data access information (914) to the identified data source (522) may be carried out by a selected data source specific plug-in of a dispatcher that passes as parameters to request the data access information (914) for the identified data source (522) without prompt.

As discussed above with reference to FIG. 5A, aggregating data of disparate data types from disparate data sources according to embodiments of the present invention typically includes identifying, to the aggregation process, disparate data sources. That is, prior to requesting data from a particular data source, that data source typically is identified to an aggregation process. In the method of FIG. 5A, for example, the data source is identified to the aggregation process by a user instruction identifying data source preferences such as the specific identification of a disparate data source. Identification of the disparate data source may also be carried out in other ways. For further explanation, therefore, FIG. 7 sets forth a flow chart illustrating an exemplary method for aggregating data of disparate data types (404), (522) from disparate data sources (402, 522) according to the present invention that includes identifying (1006), to the aggregation process (502), disparate data sources (1008). In the method of FIG. 7, identifying (1006), to the aggregation process (502), disparate data sources (1008) includes receiving (1002), from a user, a selection (1004) of the disparate data source. A user is typically a person using a data management a data rendering system to manage and render data of disparate data types (402, 408) from disparate data sources (1008) according to the present invention. Receiving (1002), from a user, a selection (1004) of the disparate data source may be carried out by receiving, through a user interface of a data management and data rendering application, from the user a user instruction containing a selection of the disparate data source and identifying (1009), to the aggregation process (502), the disparate data source (402, 522) in dependence upon the selection (1004). A user instruction is an event received in response to an act by a user such as an event created as a result of a user entering a combination of keystrokes, using a keyboard or keypad, receiving speech from a user, receiving an clicking on icons on a visual display by using a mouse, pressing an icon on a touchpad, or other use act as will occur to those of skill in the art. A user interface in a data management and data rendering application may usefully provide a vehicle for receiving user selections of particular disparate data sources.

In the example of FIG. 7, identifying disparate data sources to an aggregation process is carried out by a user. Identifying disparate data sources may also be carried out by processes that require limited or no user interaction. For further explanation, FIG. 8 sets forth a flow chart illustrating an exemplary method for aggregating data of disparate data types from disparate data sources requiring little or no user action that includes identifying (1006), to the aggregation process (502), disparate data sources (1008) includes identifying (1102), from a request for data (508), data type information (1106). Disparate data types identify data of different kind and form. That is, disparate data types are data of different kinds. The distinctions in data that define the disparate data types may include a difference in data structure, file format, protocol in which the data is transmitted, and other distinctions as will occur to those of skill in the art. Data type information (1106) is information representing these distinctions in data that define the disparate data types.

Identifying (1102), from the request for data (508), data type information (1106) according to the method of FIG. 8 may be carried out by extracting a data type code from the request for data. Alternatively, identifying (1102), from the request for data (508), data type information (1106) may be carried out by inferring the data type of the data being requested from the request itself, such as by extracting data elements from the request and inferring from those data elements the data type of the requested data, or in other ways as will occur to those of skill in the art.

In the method for aggregating of FIG. 8, identifying (1006), to the aggregation process (502), disparate data sources also includes identifying (1110), from a data source table (1104), sources of data corresponding to the data type (1116). A data source table is a table containing identification of disparate data sources indexed by the data type of the data retrieved from those disparate data sources. Identifying (1110), from a data source table (1104), sources of data corresponding to the data type (1116) may be carried out by performing a lookup on the data source table in dependence upon the identified data type. Data source tables (1104) such as the data source table of FIG. 8 may also be populated using data source preferences discussed above with reference to FIG. 5A.

In some cases no such data source may be found for the data type or no such data source table is available for identifying a disparate data source. In the method of FIG. 8 therefore includes an alternative method for identifying (1006), to the aggregation process (502), disparate data sources that includes searching (1108), in dependence upon the data type information (1106), for a data source and identifying (1114), from search results (1112) returned in the data source search, sources of data corresponding to the data type (1116). Searching (1108), in dependence upon the data type information (1106), for a data source may be carried out by creating a search engine query in dependence upon the data type information and querying the search engine with the created query. Querying a search engine may be carried out through the use of URL encoded data passed to a search engine through, for example, an HTTP GET or HTTP POST function. URL encoded data is data packaged in a URL for data communications, in this case, passing a query to a search engine. In the case of HTTP communications, the HTTP GET and POST functions are often used to transmit URL encoded data. In this context, it is useful to remember that URLs do more than merely request file transfers. URLs identify resources on servers. Such resources may be files having filenames, but the resources identified by URLs also include, for example, queries to databases. Results of such queries do not necessarily reside in files, but they are nevertheless data resources identified by URLs and identified by a search engine and query data that produce such resources. An example of URL encoded data is:
http://www.example.com/search?field1=value1&field2=value2
This example of URL encoded data representing a query that is submitted over the web to a search engine. More specifically, the example above is a URL bearing encoded data representing a query to a search engine and the query is the string “fieldl=value1&field2=value2.” The exemplary encoding method is to string field names and field values separated by ‘&’ and “=” and designate the encoding as a query by including “search” in the URL. The exemplary URL encoded search query is for explanation and not for limitation. In fact, different search engines may use different syntax in representing a query in a data encoded URL and therefore the particular syntax of the data encoding may vary according to the particular search engine queried.

Identifying (1114), from search results (1112) returned in the data source search, sources of data corresponding to the data type (1116) may be carried out by retrieving URLs to data sources from hyperlinks in a search results page returned by the search engine.

As discussed above, data management and data rendering for disparate data types includes synthesizing aggregated data of disparate data types into data of a uniform data type. For further explanation, FIG. 9 sets forth a flow chart illustrating a method for synthesizing (414) aggregated data of disparate data types (412) into data of a uniform data type. As discussed above, aggregated data of disparate data types (412) is the accumulation, in a single location, of data of disparate types. This location of the aggregated data may be either physical, such as, for example, on a single computer containing aggregated data, or logical, such as, for example, a single interface providing access to the aggregated data. Also as discussed above, disparate data types are data of different kind and form. That is, disparate data types are data of different kinds. Data of a uniform data type is data having been created or translated into a format of predetermined type. That is, uniform data types are data of a single kind that may be rendered on a device capable of rendering data of the uniform data type. Synthesizing (414) aggregated data of disparate data types (412) into data of a uniform data type advantageously makes the content of the disparate data capable of being rendered on a single device.

In the method of FIG. 9, synthesizing (414) aggregated data of disparate data types (412) into data of a uniform data type includes receiving (612) aggregated data of disparate data types. Receiving (612) aggregated data of disparate data types (412) may be carried out by receiving, from aggregation process having accumulated the disparate data, data of disparate data types from disparate sources for synthesizing into a uniform data type.

In the method for synthesizing of FIG. 9, synthesizing (414) the aggregated data (406) of disparate data types (610) into data of a uniform data type also includes translating (614) each of the aggregated data of disparate data types (610) into text (617) content and markup (619) associated with the text content. Translating (614) each of the aggregated data of disparate data types (610) into text (617) content and markup (619) associated with the text content according to the method of FIG. 9 includes representing in text and markup the content of the aggregated data such that a browser capable of rendering the text and markup may render from the translated data the same content contained in the aggregated data prior to being synthesized.

In the method of FIG. 9, translating (614) each of the aggregated data of disparate data types (610) into text (617) content and markup (619) may be carried out by creating an X+V document for the aggregated data including text, markup, grammars and so on as will be discussed in more detail below with reference to FIG. 10. The use of X+V is for explanation and not for limitation. In fact, other markup languages may be useful in synthesizing (414) the aggregated data (406) of disparate data types (610) into data of a uniform data type according to the present invention such as XML, VXML, or any other markup language as will occur to those of skill in the art.

Translating (614) each of the aggregated data of disparate data types (610) into text (617) content and markup (619) such that a browser capable of rendering the text and markup may render from the translated data the same content contained in the aggregated data prior to being synthesized may include augmenting the content in translation in some way. That is, translating aggregated data types into text and markup may result in some modification to the content of the data or may result in deletion of some content that cannot be accurately translated. The quantity of such modification and deletion will vary according to the type of data being translated as well as other factors as will occur to those of skill in the art.

Translating (614) each of the aggregated data of disparate data types (610) into text (617) content and markup (619) associated with the text content may be carried out by translating the aggregated data into text and markup and parsing the translated content dependent upon data type. Parsing the translated content dependent upon data type means identifying the structure of the translated content and identifying aspects of the content itself, and creating markup (619) representing the identified structure and content.

Consider for further explanation the following markup language depiction of a snippet of audio clip describing the president.

```
<head> original file type= ‘MP3’ keyword = ‘president’ number = ‘50’,
keyword = ‘air force’ number = ‘1’ keyword = ‘white house’
number =’2’ >
</head>
    <content>
      Some content about the president
    </content>
```

In the example above an MP3 audio file is translated into text and markup. The header in the example above identifies the translated data as having been translated from an MP3 audio file. The exemplary header also includes keywords included in the content of the translated document and the frequency with which those keywords appear. The exemplary translated data also includes content identified as ‘some content about the president.’

As discussed above with reference to FIG. 9, one useful uniform data type for synthesized data is XHTML plus Voice. XHTML plus Voice (‘X+V’) is a Web markup language for developing multimodal applications, by enabling voice with voice markup. X+V provides voice-based interaction in devices using both voice and visual elements. Voice enabling the synthesized data for data management and data rendering according to embodiments of the present invention is typically carried out by creating grammar sets for the text content of the synthesized data. A grammar is a set of words that may be spoken, patterns in which those words may be spoken, or other language elements that define the speech recognized by a speech recognition engine. Such speech recognition engines are useful in a data management and rendering engine to provide users with voice navigation of and voice interaction with synthesized data.

For further explanation, therefore, FIG. 10 sets forth a flow chart illustrating a method for synthesizing (414) aggregated data of disparate data types (412) into data of a uniform data type that includes dynamically creating sets for the text content of synthesized data for voice interaction with a user. Synthesizing (414) aggregated data of disparate data types (412) into data of a uniform data type according to the method of FIG. 10 includes receiving (612) aggregated data of disparate data types (412). As discussed above, receiving (612) aggregated data of disparate data types (412) may be carried out by receiving, from aggregation process having accumulated the disparate data, data of disparate data types from disparate sources for synthesizing into a uniform data type.

The method of FIG. 10 for synthesizing (414) aggregated data of disparate data types (412) into data of a uniform data type also includes translating (614) each of the aggregated data of disparate data types (412) into translated data (1204) comprising text content and markup associated with the text content. As discussed above, translating (614) each of the aggregated data of disparate data types (412) into text content and markup associated with the text content includes representing in text and markup the content of the aggregated data such that a browser capable of rendering the text and markup may render from the translated data the same content contained in the aggregated data prior to being synthesized. In some cases, translating (614) the aggregated data of disparate data types (412) into text content and markup such that a browser capable of rendering the text and markup may include augmenting or deleting some of the content being translated in some way as will occur to those of skill in the art.

In the method of FIG. 10, translating (1202) each of the aggregated data of disparate data types (412) into translated data (1204) comprising text content and markup may be carried out by creating an X+V document for the synthesized data including text, markup, grammars and so on as will be discussed in more detail below. The use of X+V is for explanation and not for limitation. In fact, other markup languages may be useful in translating (614) each of the aggregated data of disparate data types (412) into translated data (1204) comprising text content and markup associated with the text content as will occur to those of skill in the art.

The method of FIG. 10 for synthesizing (414) aggregated data of disparate data types (412) into data of a uniform data type may include dynamically creating (1206) grammar sets (1216) for the text content. As discussed above, a grammar is a set of words that may be spoken, patterns in which those words may be spoken, or other language elements that define the speech recognized by a speech recognition engine.

In the method of FIG. 10, dynamically creating (1206) grammar sets (1216) for the text content also includes identifying (1208) keywords (1210) in the translated data (1204) determinative of content or logical structure and including the identified keywords in a grammar associated with the translated data. Keywords determinative of content are words and phrases defining the topics of the content of the data and the information presented the content of the data. Keywords determinative of logical structure are keywords that suggest the form in which information of the content of the data is presented. Examples of logical structure include typographic structure, hierarchical structure, relational structure, and other logical structures as will occur to those of skill in the art.

Identifying (1208) keywords (1210) in the translated data (1204) determinative of content may be carried out by searching the translated text for words that occur in a text more often than some predefined threshold. The frequency of the word exceeding the threshold indicates that the word is related to the content of the translated text because the predetermined threshold is established as a frequency of use not expected to occur by chance alone. Alternatively, a threshold may also be established as a function rather than a static value. In such cases, the threshold value for frequency of a word in the translated text may be established dynamically by use of a statistical test which compares the word frequencies in the translated text with expected frequencies derived statistically from a much larger corpus. Such a larger corpus acts as a reference for general language use.

Identifying (1208) keywords (1210) in the translated data (1204) determinative of logical structure may be carried out by searching the translated data for predefined words determinative of structure. Examples of such words determinative of logical structure include ‘introduction,’ ‘table of contents,’ ‘chapter,’ ‘stanza,’ ‘index,’ and many others as will occur to those of skill in the art.

In the method of FIG. 10, dynamically creating (1206) grammar sets (1216) for the text content also includes creating (1214) grammars in dependence upon the identified keywords (1210) and grammar creation rules (1212). Grammar creation rules are a pre-defined set of instructions and grammar form for the production of grammars. Creating (1214) grammars in dependence upon the identified keywords (1210) and grammar creation rules (1212) may be carried out by use of scripting frameworks such as JavaServer Pages, Active Server Pages, PHP, Perl, XML from translated data. Such dynamically created grammars may be stored externally and referenced, in for example, X+V the <grammar src=“”/>tag that is used to reference external grammars.

The method of FIG. 10 for synthesizing (414) aggregated data of disparate data types (412) into data of a uniform data type includes associating (1220) the grammar sets (1216) with the text content. Associating (1220) the grammar sets (1216) with the text content includes inserting (1218) markup (1224) defining the created grammar into the translated data (1204). Inserting (1218) markup in the translated data (1204) may be carried out by creating markup defining the dynamically created grammar inserting the created markup into the translated document.

The method of FIG. 10 also includes associating (1222) an action (420) with the grammar. As discussed above, an action is a set of computer instructions that when executed carry out a predefined task. Associating (1222) an action (420) with the grammar thereby provides voice initiation of the action such that the associated action is invoked in response to the recognition of one or more words or phrases of the grammar.

In synthesizing aggregated data of disparate data types into data of a uniform data type, as discussed above, individual users may have unique preferences for synthesizing aggregated data of disparate data types. As discussed above synthesizing the aggregated data of disparate data types into data of a uniform data type may be carried out in dependence upon synthesis preferences. For further explanation, therefore, FIG. 10A sets forth a flow chart illustrating an exemplary method for synthesizing (442) the aggregated data of disparate data types (412) into data of a uniform data type in dependence upon synthesis preferences (436). As discussed above, synthesis preferences are user provided preferences governing aspects of synthesizing data of disparate data types. Synthesis preferences include preferences for synthesizing data of a particular data type, as well as preferences for other aspects of synthesizing the data such as the volume of data to synthesize, presentation formatting for the synthesized data, prosody preferences for aural presentation of the synthesized data, grammar preferences for synthesizing the data, and other preferences that will occur to those of skill in the art.

The method of FIG. 10A for synthesizing (442) the aggregated data of disparate data types (412) into data of a uniform data type in dependence upon synthesis preferences (436) is often carried out differently according to the native data type of the aggregated data of disparate data types (412) which is to be synthesized. The differences in carrying out synthesizing the aggregated data of each data type in dependence upon synthesis preferences (436) for each data type typically include different data type-specific synthesis preferences (640-644).

In the example of FIG. 10A, these different data type-specific synthesis preferences (640-644) include email preferences (640). Email preferences (640) are email-specific preferences governing the synthesis of aggregated data having email as its native data type. Email preferences (640) may include number of emails to synthesize, formatting for presentation of synthesized emails, preferences for synthesizing attachments to emails, prosody preferences for aural presentation of the email data (630), email-specific grammar preferences, or any other email preferences (640) as will occur to those of skill in the art.

Synthesizing (442) the aggregated data of disparate data types (412) into data of a uniform data type in dependence upon synthesis preferences (436) includes synthesizing (648) email data (630) in dependence upon the email preferences (640). Synthesizing (648) email data (630) in dependence upon email preferences (640) may be carried out by retrieving email preferences (640) in the synthesis preferences (436), identifying a particular synthesis process in dependence upon the email preferences, and executing the identified synthesis process.

In the example of FIG. 10A the synthesis preferences (436) also include calendar preferences (650). Calendar preferences (650) are calendar-specific preferences governing the synthesis of aggregated data having calendar data as its native data type. Calendar preferences (650) may include specific dates, or date ranges of calendar data (632) to synthesize, formatting preferences for presentation of synthesized calendar data, prosody preferences for aural presentation of the calendar data (632), calendar-data-specific grammar preferences, preferences for reminder processes in presenting the calendar data (632), or any other calendar preferences (642) as will occur to those of skill in the art.

Synthesizing (442) the aggregated data of disparate data types (412) into data of a uniform data type in dependence upon synthesis preferences (436) includes synthesizing (650) calendar data (632) in dependence upon the calendar preferences (642). Synthesizing (650) calendar data (632) in dependence upon calendar preferences (642) may be carried out by retrieving calendar preferences (642) in the synthesis preferences (436), identifying a particular synthesis process in dependence upon the calendar preferences, and executing the identified synthesis process.

In the example of FIG. 10A the synthesis preferences (436) include RSS preferences (652). RSS preferences (644) are RSS-specific preferences governing the synthesis of aggregated data having RSS data (634) as its native data type. RSS preferences (644) may include formatting preferences for presentation of synthesized RSS data (652), prosody preferences for aural presentation of the RSS data (634), RSS-data-specific grammar preferences, preferences for reminder processes in presenting the RSS data (634), or any other RSS preferences (644) as will occur to those of skill in the art.

Synthesizing (442) the aggregated data of disparate data types (412) into data of a uniform data type in dependence upon synthesis preferences (436) includes synthesizing (652) RSS data (634) in dependence upon the RSS preferences (644). Synthesizing (652) RSS data (634) in dependence upon RSS preferences (644) may be carried out by retrieving RSS preferences (644) in the synthesis preferences (436), identifying a particular synthesis process in dependence upon the RSS preferences, and executing the identified synthesis process.

As discussed above, synthesizing aggregated data of disparate data types into data of a uniform data type in dependence upon synthesis preferences is often carried out differently according to the native data type of the aggregated data to be synthesized. One common native data type useful in data management and data rendering according to the present invention is RSS content. For further explanation, therefore, FIG. 10B sets forth a flow chart illustrating a method for management and rendering of RSS content according to the present invention that includes receiving aggregated RSS content in native form. RSS content includes both a RSS feed-also known as a webfeed, RSS stream, or RSS channel—and web content. An RSS feed is typically implemented as one or more XML files containing summaries of web content accompanied by links to more extensive versions of the content at a RSS content source, as well as other meta-data. The RSS web content is typically content of disparate data types from a RSS content source which is identified by and accessible through an RSS feed.

As discussed above, RSS is a family of XML file formats for web syndication used by news websites and weblogs. The abbreviation is used to refer to the following standards: Rich Site Summary (RSS 0.91), RDF Site Summary (RSS 0.9, 1.0 and 1.1), and Really Simple Syndication (RSS 2.0). RSS is a format often used for syndicating news and the content of news-like sites, including major news sites, news-oriented community sites, and personal weblogs. RSS allows users to see some of a web site's content, in the form of items which are created from the website's associated RSS feed, without requiring the user to visit the web site directly. If the user would like to view the full content of the item, the user may activate a link to browse the website featuring the full content of the channel or item.

Receiving (654) aggregated RSS content in native form (656) may be carried out by receiving from an aggregation process aggregated RSS content in native form (656). Such an aggregation process may retrieve RSS content in native form by calling a RSS content plug-in in a dispatcher designed to retrieve RSS content from a predesignated RSS content server and return the retrieved RSS content to the aggregation process.

RSS content in native form, as illustrated in FIG. 10B, typically includes one or more ‘native RSS channels’. A native RSS channel is a container for an arbitrary number of items of a similar type, having some relationship which is defined by the context of the container. A native RSS channel is typically a reverse-chronological sorted list of links to stories, along with metadata for each story often indicating the title of each story and a description of each story.

The term ‘native RSS channel’ in the description of FIG. 10B is used to distinguish channels in native RSS from channels created as a result of channelizing synthesized data. A native RSS channel is a container for an arbitrary number of items of a similar type, having some relationship which is defined by the context of the container. A channel created by channelizing synthesized data according to the present invention is a logical aggregation of synthesized data content for presentation to a user channelized by identifying attributes of the synthesized data, characterizing the attributes of the synthesized data, and assigning the data to a predetermined channel in dependence upon the characterized attributes and channel assignment rules.

Each native RSS channel is designated by markup in the RSS feed's XML files and has required sub-elements which are also designated by markup. Required sub-elements of a native RSS channel include a title to name the native RSS channel, a link, and a description. The link is the URL of an ordinary web page, such as, for example, a web page written in HTML, corresponding to the native RSS channel. Each native RSS channel may also contain optional sub-elements. Optional sub-elements of a native RSS channel include, for example, the image sub-element of the native RSS channel, which provides for an image to be displayed in connection with the native RSS channel. Another required sub-element of native RSS channels is at least one an item (657). A native RSS channel contains at least one item (657).

An item (657) is a sub-element of a native RSS channel representing a distinct collection of information in a RSS feed. An item (657) contains sub-elements designated by markup which provide to an RSS aggregator information about the item (657). An RSS aggregator is software designed to parse and display RSS feeds chosen by a user. The RSS aggregator is should not be confused with the aggregation process or the aggregation module of the present invention discussed above, although the aggregation process and the aggregation module of the present invention are capable of aggregating and parsing RSS feeds. Each item (657) of a native RSS channel must contain either a title sub-element or a description sub-element. The title sub-element of an item of FIG. 10B designates the title of the item. The description sub-element designates an item's synopsis.

Each item may also contain optional sub-elements including link, author, guid, pubdate, source, and other optional sub-elements as will occur to those of skill in the art. The link sub-element provides the URL of the item. The author sub-element provides the email address of the author of the item. The guid, which stands for globally unique identifier, sub-element of an item designates a string which uniquely identifies the item. When present, an RSS aggregator may compare this unique guid with items that have been previously aggregated in order to determine if the item is new. No rules exist for the syntax of a guid, so aggregators must view guids as a string. The source of the feed is responsible for establishing the uniqueness of the string. The sub-element pubdate indicates when the item was published. The sub-element source designates a value which names the RSS channel that the item came from, derived from the item's title. The source sub-element has one required attribute, url, which links to the first source to issue the item in XML form. The source sub-element can be used in the Post command of an aggregator, and this source sub-element should be generated automatically when forwarding an item from an RSS aggregator to a weblog authoring tool.

For further explanation, consider an exemplary item (657) which represents an article on a web site, which is similar to a story in a newspaper or magazine:

<item>
<description>The Aurora, Illinois Spring Festival benefited from good
weather, but attendance was poor due to several unforeseeable
problems.</description>
<title> Sun Not Enough for Aurora's Spring Festival </title>
<link>www.dailyaurorannews.com/ed/2005/Apr/14/som.html</link>
<author> bobjones@www.dailyaurorannews.com </author>
<guid>http:// www.dailyaurorannews.com /RSSItem322307</guid>
<pubdate>Thur, 14 April, 2005 13:21:31 CST</pubdate>
<source url= “http:// www.dialyaurorannews.com/links2.xml”>Sun Not
Enough for Aurora's Spring Festival</source>
</item>

In the exemplary item (657) above, the item is denoted by the markup tags <item> and </item> and identified by a unique guid value, “http://www.dialyaurorannews.com /RSSItem322307”, designated by the markup tags <guid> and </guid>. Markup tags such as <description>, </description>, <title>, </title>, <link>, </link>, <author>, </author>, <pubdate>, </pubdate>, <source>, and </source> are used to advantageously provide information about the item to an RSS aggregator. In the example above, an item with the title “Sun Not Enough for Aurora's Spring Festival” has a short description of the article which the item represents: “The Aurora, Illinois Spring Festival benefited from good weather, but attendance was poor due to several unforeseeable factors.” In the same example, the item contains a URL in a link sub-element, “www.dialyaurorannews.com/ed/2005/Apr/14/som.html.” This URL may be selected in order to access the entire article. The item's markup also provides the email address of the author of the article, which is “bobjones@www.dialyaurorannews.com,” and uniquely identifies the item as guid “http://www.dialyaurorannews.com/RSSItem322307.”The item's markup designates the publication date of the article as Thursday, Apr. 14, 2005 at 1:21 pm CST. The item's markup also designates the original source of the RSS feed, corresponding to the website hosting the article listed above, as “http://www.dialyaurorannews.com/links2.xml.”

The method for management and rendering of RSS content of FIG. 10B also includes aggregating (702) RSS content in native form (656). In the method of FIG. 10B, aggregating (702) RSS content in native form (656) includes identifying (708) new items in a RSS feed (716) in native form (656) and retrieving (710) the identified new items from a RSS content source (718). As discussed above, an RSS feed (716) is typically implemented as one or more XML files containing summaries of web content accompanied by links to more extensive versions of the content at a RSS content source (718), as well as other meta-data. An RSS content source (718) is typically an Internet website on a web server, capable of being browsed by a standard HTML-based browser, which provides more extensive versions of the content identified by the RSS feed.

Identifying (708) new items in an RSS feed (716) in native form (656) according to the method of FIG. 10B may also include identifying a guid sub-element present in items of the RSS feed (716), determining the value contained in the guid sub-element, and comparing the determined value with guid values stored from previously aggregated items of the RSS feed (716). Identifying (708) new items in a RSS feed (716) in native form (656) may be carried out by periodically polling the URL hosting the RSS feed file, by polling the URL hosting the RSS feed file upon receiving notifications of events, or in other ways as will occur to those of skill in the art.

Identifying (708) new items in an RSS feed (716) in native form (656) according to the method of FIG. 10B may include identifying (712) the new items in dependence upon RSS aggregation preferences (704). RSS aggregation preferences (704) are RSS-specific preferences governing the identification of new items from an RSS feed and the retrieval of the new items from an RSS source. RSS aggregation preferences (704) may include, for example, new item identification preferences (705) that include, for example, preferences for specific types of content of new items, preferences for specific data types of content to be retrieved from an RSS source, preferences governing the frequency with which URLs hosting RSS feed files are polled, preferences defining the events which will trigger such polling, and other preferences as will occur to those of skill in the art. Identifying (712) the new items in dependence upon RSS aggregation preferences (704) may be carried out by performing a look-up in a look-up table containing RSS aggregation preferences (704) and indexed by an RSS feed identification.

RSS aggregation preferences (704) may also include retrieval preferences (706). In the method of 10B, retrieving (710) the identified new items from a RSS content source (718) also includes retrieving (714) the new items in dependence upon retrieval preferences (706) of RSS aggregation preferences (704). As discussed above, RSS aggregation preferences (704) are RSS-specific preferences governing the aggregation of RSS content in native form (656). RSS aggregation preferences (704) may include retrieval preferences (706), governing retrieving (710) identified new items from a RSS content source (718). Such preferences governing retrieving (710) identified new items from a RSS content source (718) may include, for example, preferences specifying particular time periods for retrieving the identified new items, preferences defining retrieval of new items based upon connectivity, and other retrieval preferences of RSS aggregation preferences as will occur to those of skill in the art.

Retrieving (710) the identified new items from a RSS content source (718) may be carried out by sending a request to the RSS content source and receiving a response from the RSS content source containing the new items. Sending a request to the RSS content source is carried out by sending a request for the web page containing the more extensive version of the item to the RSS content source at a URL designated by the link sub-element in the item of the RSS feed. Receiving a response from the RSS content source may be carried out by receiving a browsable response from the RSS content source, typically in the form of HTML or XHTML web pages which may be accompanied by images, video presentation, or audio presentation.

For further explanation, consider the following exemplary RSS aggregation preferences (704):

RSS Aggregation Preferences:

Preference 1:

Preference type: Identification Preferences

Keywords: “stock split” AND “PATCO”;

The exemplary RSS aggregation preferences above are designated as identification preferences for identifying new items in RSS feeds for retrieval. The exemplary RSS aggregation preference include a ‘Preference type:’ field identifying the RSS aggregation preferences as identification preferences. The text RSS aggregation preferences includes keywords “stock split” AND “PATCO”; specifying that new items that include the keywords “stock split” and “PATCO” in the description or title of an RSS feed are to be identified for retrieval.

For still further explanation, consider the following exemplary RSS aggregation preferences (704):

RSS Aggregation Preferences:

Preference 2:

Preference type: Retrieval Preferences

Timing: Retrieve new items at 6:00 am and 6:00 pm

The exemplary RSS aggregation preferences above are designated as retrieval preferences for retrieving previously identified new items in RSS feeds. The exemplary RSS aggregation preference include a ‘Preference type:’ field identifying the RSS aggregation preferences as retrieval preferences. The preferences above also include a timing field identifying that new items are to be retrieved at 6:00 am and 6:00 pm.

The method of FIG. 10B also includes synthesizing (720) the items (657) of the aggregated native form RSS content (656) into a synthesized RSS content (676). Synthesizing (720) the items of the aggregated native form RSS content (656) into synthesized RSS content (676) includes translating (670) aspects (658) of the items of the aggregated native form RSS content (656) into uniform text and markup (672). The aspects (658) of the items of the aggregated native form RSS content (656) to be translated are typically various sub-elements of the aggregated native form RSS content (656) predetermined to be contained in the synthesized RSS content (676). Such sub-elements of the RSS content predetermined to be contained in the synthesized RSS content (676) may include, for example, source and guid information of an item (657) in native form RSS content.

Translating (670) aspects (658) of the items (657) of the aggregated native form RSS content (656) into uniform text and markup (672) is often carried out by extracting an item (657) from the native RSS content. Extracting an item (657) from the native RSS content may be carried out by identifying an item (657) in native RSS content and extracting the aspects of the item (657) for translation. An item (657) may be identified by, for example, one or more markup tags in the native form RSS content, such as, for example, <item> and </item>.

Translating (670) aspects (658) of the items (657) of the aggregated native form RSS content (656) into uniform text and markup (672) according to the method of 10B is also often carried out by creating, in dependence upon native markup containing item information, text and markup (672) for presenting 680 synthesized RSS content (676). As discussed above, native RSS content is often already in the form of text and markup. Translating (670) aspects (658) of the items (657) of the aggregated native form RSS content (656) into uniform text and markup (672), therefore, may also be carried out by maintaining pre-existing native markup in the native RSS content and creating additional text and markup (672) in dependence upon aspects (658) of the items (657) of the aggregated native form RSS content (656).

The method of FIG. 10B for synthesizing (720) the items of the aggregated native form RSS content (656) into synthesized RSS content (676) may include dynamically creating grammar sets for the synthesized RSS content (676). As discussed above, a grammar is a set of words that may be spoken, patterns in which those words may be spoken, or other language elements that define the speech recognized by a speech recognition engine. The grammars provide voice enablement for the synthesized RSS content (676).

Although the aggregated native form RSS content (656) is often translated in groups of items (657), the individuality of each singular item (657) in the native form RSS content (656) is often preserved in the synthesized items, thereby preserving individual presentation of each item (657) to the user. As mentioned above, translating aggregated data types often results in some modification to the content of the data or may result in deletion of some content that cannot be accurately translated with the quantity of data lost dependent upon implementation, settings, and other factors as will occur to those of skill in the art.

The method of FIG. 10B also includes presenting (680) synthesized RSS content (676). Presenting (680) the synthesized RSS content (676) may be carried out by visually displaying the synthesized RSS content (676), speech rendering the synthesized RSS content (676), and other ways of presenting (680) synthesized RSS content (676) as will occur to those of skill in the art.

Presenting (680) synthesized RSS content (676) according the method of FIG. 10B may be carried out by presenting the RSS content (676) according to the translated text and markup (672). The translated text and markup up often defined presentation aspects of the synthesized RSS content such as display text identifying source information, link information, authorship information, and publication date information.

In the method of FIG. 10B, presenting (680) synthesized RSS content (676) also includes identifying (682) a presentation action (688) in dependence upon presentation rules (684) and executing (692) the presentation action (688). A presentation action (688) is typically implemented as software carrying out the presentation of the synthesized RSS content (676). Such presentation actions (688) include software for visually displaying the content of the synthesized RSS content (676), speech rendering the synthesized RSS content (676), and so on.

A presentation rule (684) is a set of conditions governing the selection of a one or more particular presentation actions (688) to present a particular portion of a particular synthesized RSS content (676). Such presentation rules (684) often select a particular presentation action (688) in dependence upon synthesized RSS content (676), the conditions of the device upon which the synthesized RSS content (676) is rendered, and other factors as will occur to those of skill in the art. For further explanation, consider the following exemplary presentation rule:

IF received user command = ‘Read Today's News’; AND
Device = ‘laptop computer’ ; AND
State of Device = ‘cover closed’;
THEN Presentation Action =
Read_CurrentDay_RSS_TopStories_To_BluetoothHeadset( ).

In the exemplary presentation rule above, a particular presentation action (688) called Read_CurrentDay_RSS_TopStories_To_BlueToothHeadset( ) is identified when three particular conditions are met. Those particular conditions are that the user command ‘Read Today's News’ is received by a data management and data rendering module on a laptop computer whose cover is closed. The identified presentation action (688) Read_CurrentDay_RSS_TopStories_To_BluetoothHeadset( ) is software designed to establish a Bluetooth connection with a user's headset and invoke a speech engine that presents as speech the synthesized RSS content (676) from the current day.

“Bluetooth” refers to an industrial specification for a short-range radio technology for RF couplings among client devices and between client devices and resources on a LAN or other network. An administrative body called the Bluetooth Special Interest Group tests and qualifies devices as Bluetooth compliant. The Bluetooth specification consists of a ‘Foundation Core,’ which provides design specifications, and a ‘Foundation Profile,’ which provides interoperability guidelines.

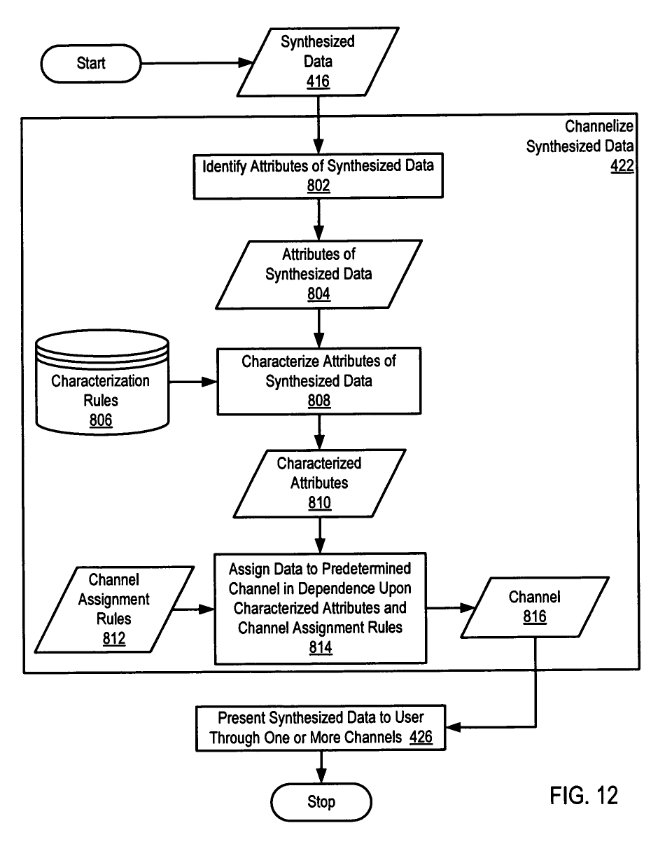

Synthesized data is often presented through one or more channels as discussed below with reference to FIG. 12. Presenting (680) the synthesized RSS content (676) according to the method of FIG. 10B may also include presenting the synthesized RSS content (676) through one or more assigned channels.

To reduce the time a user must devote to browsing through synthesized RSS content (676) in order to access desired content, management and rendering of RSS content according to the present invention may usefully provide synthesized RSS content prioritized according to user preferences. Such prioritized synthesized RSS content advantageously provides the user with a vehicle for browsing the highest priority RSS content first, and the lowest priority RSS content last, or not at all, and so on.

For further explanation, therefore, FIG. 10C sets forth a flow chart illustrating an exemplary method for management and rendering of RSS content that includes identifying (306), according to prioritization rules (304), priority characteristics (308) in the aggregated native form RSS content (656). Priority characteristics (308) useful in prioritizing (310) synthesized RSS content (676, FIG. 10B) according to prioritization rules (304) are aspects of the aggregated native form RSS content (656) that are predesignated as determinative of priority. Aspects of the aggregated native form RSS content (656) that are predesignated as determinative of priority often include particular sub-elements of elements of the synthesized RSS content (676, FIG. 10B) containing particular values. Examples of priority characteristics (308) include a source sub-element with a value defining the sources, such as “www.latimes.com”; an author sub-element containing a value identifying the author, such as “bobj@funnyplace.com”; predetermined names or keywords found in text content of the description sub-element; and other priority characteristics as will occur to those of skill in the art.

Prioritization rules (304) are predefined rules for identifying priority characteristics (308) in the aggregated native form RSS content (656). Such prioritization rules (304) often not only identify RSS content as priority RSS content but also include hierarchical priority assignments of synthesized items of the RSS content (656). For further explanation consider the following prioritization rule:

IF item's description sub-element contains keyword phrase: ‘Global Giant
Enterprises’; AND
item's description sub-element contains keyword: ‘merger’;
THEN
item priority = ‘high.’

In the exemplary prioritization rule if the description sub-element of an item contains both keywords, ‘Global Giant Enterprises’ and ‘merger,’ then the item is assigned a high priority. Prioritization rules advantageously provide a vehicle for both identifying items of importance and also ranking the items in order of their relative importance.

Synthesizing (648) the aggregated native form RSS content (656) into synthesized RSS content (676, FIG. 10B) according to the method of FIG. 10C includes prioritizing (310) the synthesized items (333, FIG. 10B) of the synthesized RSS content (676, FIG. 10B) according to the priority characteristics (308). Prioritizing (310) the synthesized RSS content (676, FIG. 10B) according to the priority characteristics (308) is carried out by creating (312) priority markup (314) representing the priority characteristics (308) and associating (316) the priority markup (314) with synthesized RSS content (676, FIG. 10B).

One way of associating (316) the priority markup (314) with synthesized RSS content (676, FIG. 10B) includes creating (318) a RSS priority markup document (324) and inserting (320) the priority markup (314) into an RSS priority markup document (324). A RSS priority markup document (324) is a document accessible by the data navigation and data rendering engine useful in presenting portions of synthesized RSS content (676, FIG.10 B) according to assigned priorities. For further explanation consider the following snippet of a RSS priority markup document (324):

```
<head>
<document = ‘RSS priority markup document’>
</head>
      . . .
    <body>
      < item ID = 1232 priority = high; item ID = 0004 priority = low;
      item ID = 1111 priority = low; item ID = 1222 priority = medium>
    </body>
```

In the exemplary RSS priority markup document (324) above, synthesized items in synthesized RSS content (676, FIG. 10B) are identified by unique item ID and a priority markup is associated with each item ID. In the example above, an item identified as item ID ‘1232’ is assigned a ‘high’ priority. In the same example, a item identified as item ID ‘0004’ is assigned a ‘low’ priority, and a item identified as item ID ‘1111 ’ is assigned a ‘low’ priority, and a item identified as item ID ‘1222’ is assigned a ‘medium’ priority. The exemplary RSS priority markup document (324) is presented for explanation and not for limitation. In fact, RSS priority markup documents (324) according to the present invention may be implemented in many ways and all such implementations are well within the scope of the present invention.

The method of FIG. 10C also includes presenting the synthesized RSS content. In the method of FIG. 10C, presenting (680) the synthesized RSS content (676, FIG. 10B) according to the method of FIG. 10C includes presenting 328 one or more of the prioritized items of the synthesized RSS content (676, FIG. 10B). Presenting (328) one or more of the prioritized items of the prioritized synthesized RSS content (326) may be carried out by presenting the prioritized items of the prioritized synthesized RSS content (326) according to priorities assigned in a RSS priority markup document (324). Presenting the prioritized items according to priorities assigned in a RSS priority markup document (324) may be carried out by retrieving an assigned priority from the RSS priority markup document (324) and presenting the prioritized items according to the retrieved assigned priority.

Presenting (328) a prioritized item may be carried out by displaying a prioritized item visually with added display emphasis according to priority, displaying prioritized items visually in order according to priority, presenting a prioritized item with icons representing their assigned priority, aurally presenting the content of a prioritized item with added speech emphasis according to priority, aurally presenting prioritized items in order according to priority, playing earcons identifying the priority of a prioritized item, and so on as will occur to those of skill in the art.

The prioritized items may also be prioritized in dependence upon user-defined RSS preferences. For further explanation, FIG. 10 D sets forth a flow chart illustrating an exemplary method for creating prioritization rules from user defined RSS preferences. As discussed above, RSS preferences (644) are RSS-specific preferences governing the synthesis of aggregated data having RSS content as its native data type. RSS preferences (644) may include number of items to synthesize, number of sources to synthesize, formatting for presentation of synthesized RSS content, prosody preferences for aural presentation of the RSS content, RSS-specific grammar preferences, or any other RSS preferences (644) as will occur to those of skill in the art. RSS preferences may also include explicit priority designations useful in creating prioritization rules such as items with particular sources to be designated as high priority, keywords in descriptions to designated as high priority, and so on as will occur to those of skill in the art.

The method of FIG. 10D includes receiving (435) RSS preferences (644) from a user (438). Receiving (435) RSS preferences (644) from a user (438) may be carried out by receiving a user instruction to set a RSS preference (644). Such a user instruction may be received through a selection screen having GUI input boxes for receiving user instructions, selection menus designed to received user selections, and so on as will occur to those of skill in the art. Receiving (435) RSS preferences (644) may also include receiving an explicit RSS priority preference.

The method of FIG. 10D also includes creating (302) prioritization rules (304) in dependence upon the RSS preferences (644) for synthesizing RSS content. Creating (302) prioritization rules (304) in dependence upon the RSS preferences (644) for synthesizing RSS content may therefore be carried out by creating a prioritization rule (304) in dependence upon the RSS priority preference. For further explanation consider the following example of a prioritization rule (304) created in dependence upon an explicit user priority preference that defines all synthesized items with a source sub-element containing a designated source from a priority source list as high priority.

```
PrioritySourceList = {www.kcstar.com, www.dallasmorningnews.com}
    If source on PrioritySourceList;
      THEN RSS priority = ‘High’.
```

In this example, a user has selected www.kcstar.com and www.dallasmorningnews.com as priority sources. A RSS prioritization rule therefore assigns a high priority to any synthesized items with www.kcstar.com or www.dallasmorningnews.com as sources.

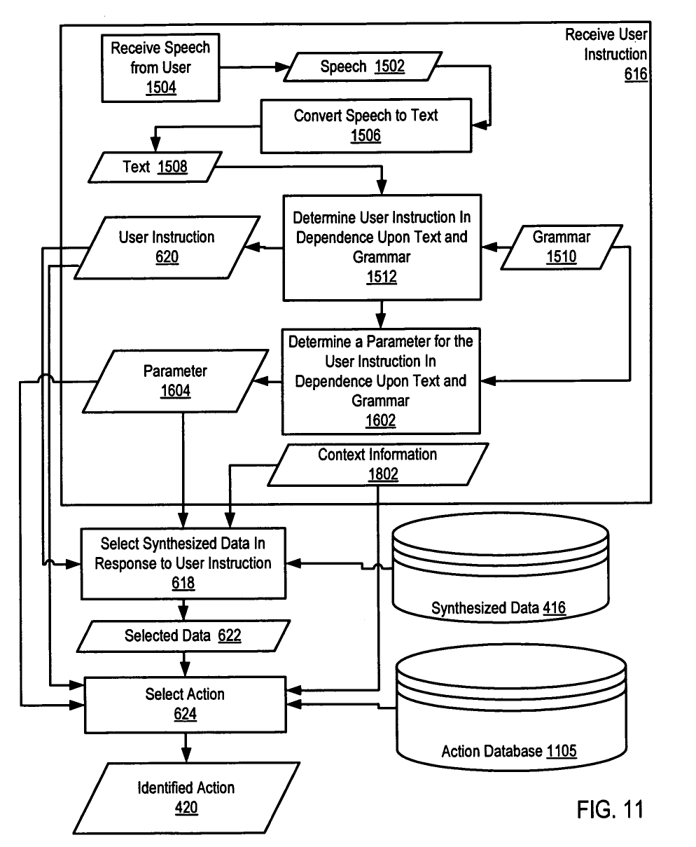

As discussed above, data management and data rendering for disparate data types includes identifying an action in dependence upon the synthesized data. For further explanation, FIG. 11 sets forth a flow chart illustrating an exemplary method for identifying an action in dependence upon the synthesized data (416) including receiving (616) a user instruction (620) and identifying an action in dependence upon the synthesized data (416) and the user instruction. In the method of FIG. 11, identifying an action may be carried out by retrieving an action ID from an action list. In the method of FIG. 11, retrieving an action ID from an action list includes retrieving from a list the identification of the action (the ‘action ID’) to be executed in dependence upon the user instruction and the synthesized data. The action list can be implemented, for example, as a Java list container, as a table in random access memory, as a SQL database table with storage on a hard drive or CD ROM, and in other ways as will occur to those of skill in the art. As mentioned above, the actions themselves comprise software, and so can be implemented as concrete action classes embodied, for example, in a Java package imported into a data management and data rendering module at compile time and therefore always available during run time.

In the method of FIG. 11, receiving (616) a user instruction (620) includes receiving (1504) speech (1502) from a user, converting (1506) the speech (1502) to text (1508); determining (1512) in dependence upon the text (1508) and a grammar (1510) the user instruction (620) and determining (1602) in dependence upon the text (1508) and a grammar (1510) a parameter (1604) for the user instruction (620). As discussed above with reference to FIG. 4, a user instruction is an event received in response to an act by a user. A parameter to a user instruction is additional data further defining the instruction. For example, a user instruction for ‘delete email’ may include the parameter ‘Aug. 11, 2005’ defining that the email of Aug. 11, 2005 is the synthesized data upon which the action invoked by the user instruction is to be performed. Receiving (1504) speech (1502) from a user, converting (1506) the speech (1502) to text (1508); determining (1512) in dependence upon the text (1508) and a grammar (1510) the user instruction (620); and determining (1602) in dependence upon the text (1508) and a grammar (1510) a parameter (1604) for the user instruction (620) may be carried out by a speech recognition engine incorporated into a data management and data rendering module according to the present invention.

Identifying an action in dependence upon the synthesized data (416) according to the method of FIG. 11 also includes selecting (618) synthesized data (416) in response to the user instruction (620). Selecting (618) synthesized data (416) in response to the user instruction (620) may be carried out by selecting synthesized data identified by the user instruction (620). Selecting (618) synthesized data (416) may also be carried out by selecting the synthesized data (416) in dependence upon a parameter (1604) of the user instruction (620).

Selecting (618) synthesized data (416) in response to the user instruction (620) may be carried out by selecting synthesized data context information 1802. Context information is data describing the context in which the user instruction is received such as, for example, state information of currently displayed synthesized data, time of day, day of week, system configuration, properties of the synthesized data, or other context information as will occur to those of skill in the art. Context information may be usefully used instead or in conjunction with parameters to the user instruction identified in the speech. For example, the context information identifying that synthesized data translated from an email document is currently being displayed may be used to supplement the speech user instruction ‘delete email’ to identify upon which synthesized data to perform the action for deleting an email.

Identifying an action in dependence upon the synthesized data (416) according to the method of FIG. 11 also includes selecting (624) an action (420) in dependence upon the user instruction (620) and the selected data (622). Selecting (624) an action (420) in dependence upon the user instruction (620) and the selected data (622) may be carried out by selecting an action identified by the user instruction. Selecting (624) an action (420) may also be carried out by selecting the action (420) in dependence upon a parameter (1604) of the user instructions (620) and by selecting the action (420) in dependence upon a context information (1802). In the example of FIG. 11, selecting (624) an action (420) is carried out by retrieving an action from an action database 1105 in dependence upon one or more a user instructions, parameters, or context information.

Executing the identified action may be carried out by use of a switch( ) statement in an action agent of a data management and data rendering module. Such a switch( ) statement can be operated in dependence upon the action ID and implemented, for example, as illustrated by the following segment of pseudocode:

```
switch (actionID) {
      Case 1: actionNumber1.take_action( ); break;
      Case 2: actionNumber2.take_action( ); break;
      Case 3: actionNumber3.take_action( ); break;
      Case 4: actionNumber4.take_action( ); break;
      Case 5: actionNumber5.take_action( ); break;
      // and so on
} // end switch( )
```

The exemplary switch statement selects an action to be performed on synthesized data for execution depending on the action ID. The tasks administered by the switch( ) in this example are concrete action classes named actionNumberl, actionNumber2, and so on, each having an executable member method named ‘take_action( ),’ which carries out the actual work implemented by each action class.

Executing an action may also be carried out in such embodiments by use of a hash table in an action agent of a data management and data rendering module. Such a hash table can store references to action object keyed by action ID, as shown in the following pseudocode example. This example begins by an action service's creating a hashtable of actions, references to objects of concrete action classes associated with a user instruction. In many embodiments it is an action service that creates such a hashtable, fills it with references to action objects pertinent to a particular user instruction, and returns a reference to the hashtable to a calling action agent.

Hashtable ActionHashTable = new Hashtable( );
ActionHashTable.put(“1”, new Action1( ));
ActionHashTable.put(“2”, new Action2( ));
ActionHashTable.put(“3”, new Action3( ));

Executing a particular action then can be carried out according to the following pseudocode:

Action anAction = (Action) ActionHashTable.get(“2”);
if (anAction != null) anAction.take_action( );

Executing an action may also be carried out by use of list. Lists often function similarly to hashtables. Executing a particular action, for example, can be carried out according to the following pseudocode:

List ActionList = new List( );
ActionList.add(1, new Action1( ));
ActionList.add(2, new Action2( ));
ActionList.add(3, new Action3( ));

Executing a particular action then can be carried out according to the following pseudocode:

Action anAction = (Action) ActionList.get(2);
if (anAction != null) anAction.take_action( );

The three examples above use switch statements, hash tables, and list objects to explain executing actions according to embodiments of the present invention. The use of switch statements, hash tables, and list objects in these examples are for explanation, not for limitation. In fact, there are many ways of executing actions according to embodiments of the present invention, as will occur to those of skill in the art, and all such ways are well within the scope of the present invention.

For further explanation of identifying an action in dependence upon the synthesized data consider the following example of user instruction that identifies an action, a parameter for the action, and the synthesized data upon which to perform the action. A user is currently viewing synthesized data translated from email and issues the following speech instruction: “Delete email dated Aug. 15, 2005.”In the current example, identifying an action in dependence upon the synthesized data is carried out by selecting an action to delete and synthesized data in dependence upon the user instruction, by identifying a parameter for the delete email action identifying that only one email is to be deleted, and by selecting synthesized data translated from the email of Aug. 15, 2005 in response to the user instruction.

For further explanation of identifying an action in dependence upon the synthesized data consider the following example of user instruction that does not specifically identify the synthesized data upon which to perform an action. A user is currently viewing synthesized data translated from a series of emails and issues the following speech instruction: “Delete current email.” In the current example, identifying an action in dependence upon the synthesized data is carried out by selecting an action to delete synthesized data in dependence upon the user instruction. Selecting synthesized data upon which to perform the action, however, in this example is carried out in dependence upon the following data selection rule that makes use of context information.

```
If synthesized data = displayed;
    Then synthesized data = ‘current’.
If synthesized includes = email type code;
    Then synthesized data = email.
```

The exemplary data selection rule above identifies that if synthesized data is displayed then the displayed synthesized data is ‘current’ and if the synthesized data includes an email type code then the synthesized data is email. Context information is used to identify currently displayed synthesized data translated from an email and bearing an email type code. Applying the data selection rule to the exemplary user instruction “delete current email” therefore results in deleting currently displayed synthesized data having an email type code.

As discussed above, data management and data rendering for disparate data types often includes channelizing the synthesized data. Channelizing the synthesized data (416) advantageously results in the separation of synthesized data into logical channels. A channel implemented as a logical accumulation of synthesized data sharing common attributes having similar characteristics. Examples of such channels are ‘entertainment channel’ for synthesized data relating to entertainment, ‘work channel’ for synthesized data relating to work, ‘family channel’ for synthesized data relating to a user's family and so on.

For further explanation, therefore, FIG. 12 sets forth a flow chart illustrating an exemplary method for channelizing (422) the synthesized data (416) according to embodiments of the present invention, which includes identifying (802) attributes of the synthesized data (804). Attributes of synthesized data (804) are aspects of the data which may be used to characterize the synthesized data (416). Exemplary attributes (804) include the type of the data, metadata present in the data, logical structure of the data, presence of particular keywords in the content of the data, the source of the data, the application that created the data, URL of the source, author, subject, date created, and so on. Identifying (802) attributes of the synthesized data (804) may be carried out by comparing contents of the synthesized data (804) with a list of predefined attributes. Another way that identifying (802) attributes of the synthesized data (804) may be carried out by comparing metadata associated with the synthesized data (804) with a list of predefined attributes.

The method of FIG. 12 for channelizing (422) the synthesized data (416) also includes characterizing (808) the attributes of the synthesized data (804). Characterizing (808) the attributes of the synthesized data (804) may be carried out by evaluating the identified attributes of the synthesized data. Evaluating the identified attributes of the synthesized data may include applying a characterization rule (806) to an identified attribute. For further explanation consider the following characterization rule:

If synthesized data = email; AND
If email to = “Joe”; AND
If email from = “Bob”;
Then email = ‘work email.’

In the example above, the characterization rule dictates that if synthesized data is an email and if the email was sent to “Joe” and if the email sent from “Bob” then the exemplary email is characterized as a ‘work email.’

Characterizing (808) the attributes of the synthesized data (804) may further be carried out by creating, for each attribute identified, a characteristic tag representing a characterization for the identified attribute. Consider for further explanation the following example of synthesized data translated from an email having inserted within it a characteristic tag.

```
<head >
original message type = ‘email’ to = ‘joe’ from = ‘bob’ re = ‘I will be late
tomorrow’</head>
    <characteristic>
        characteristic = ‘work’
    <characteristic>
    <body>
        Some body content
    </body>
```

In the example above, the synthesized data is translated from an email sent to Joe from ‘Bob’ having a subject line including the text ‘I will be late tomorrow. In the example above <characteristic> tags identify a characteristic field having the value ‘work’ characterizing the email as work related. Characteristic tags aid in channelizing synthesized data by identifying characteristics of the data useful in channelizing the data.

The method of FIG. 12 for channelizing (422) the synthesized data (416) also includes assigning (814) the data to a predetermined channel (816) in dependence upon the characterized attributes (810) and channel assignment rules (812). Channel assignment rules (812) are predetermined instructions for assigning synthesized data (416) into a channel in dependence upon characterized attributes (810). Consider for further explanation the following channel assignment rule:

If synthesized data = ‘email’; and
If Characterization = ‘work related email’
Then channel = ‘work channel.’

In the example above, if the synthesized data is translated from an email and if the email has been characterized as ‘work related email’ then the synthesized data is assigned to a ‘work channel.’

Assigning (814) the data to a predetermined channel (816) may also be carried out in dependence upon user preferences, and other factors as will occur to those of skill in the art. User preferences are a collection of user choices as to configuration, often kept in a data structure isolated from business logic. User preferences provide additional granularity for channelizing synthesized data according to the present invention.

Under some channel assignment rules (812), synthesized data (416) may be assigned to more than one channel (816). That is, the same synthesized data may in fact be applicable to more than one channel. Assigning (814) the data to a predetermined channel (816) may therefore be carried out more than once for a single portion of synthesized data.

The method of FIG. 12 for channelizing (422) the synthesized data (416) may also include presenting 426 the synthesized data (416) to a user through one or more channels (816). One way presenting 426 the synthesized data (416) to a user through one or more channels (816) may be carried out is by presenting summaries or headings of available channels in a user interface allowing a user access to the content of those channels. These channels could be accessed via this presentation in order to access the synthesized data (416). The synthesized data is additionally to the user through the selected channels by displaying or playing the synthesized data (416) contained in the channel.

Exemplary embodiments of the present invention are described largely in the context of a fully fuctional computer system for management and rendering of RSS data. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A computer-implemented method for management and rendering of RSS content, the method comprising:
receiving aggregated RSS content in native form;
synthesizing the items of the aggregated native form RSS content into synthesized RSS content; and
presenting the synthesized RSS content.

2. The method of claim 1 wherein synthesizing items of the aggregated native form RSS content into synthesized RSS content further comprises translating aspects of the items of the aggregated native form RSS content into uniform text and markup.

3. The method of claim 1 further comprising aggregating RSS content in native form including:
identifying new items in an RSS feed in native form; and
retrieving the identified new items from an RSS content source.

4. The method of claim 3 wherein identifying new items in an RSS feed in native form further comprises:
identifying the new items in dependence upon RSS aggregation preferences from a user.

5. The method of claim 3 wherein retrieving the identified new items from an RSS content source further comprises:
retrieving the new items in dependence upon RSS aggregation preferences from a user.

6. The method of claim 1 further comprising:
identifying, according to prioritization rules, priority characteristics in the aggregated native form RSS content; and wherein:
synthesizing the items of the aggregated native form RSS content into synthesized RSS content further comprises prioritizing the items of the synthesized RSS content according to the priority characteristics; and
presenting the synthesized RSS content further comprises presenting the prioritized synthesized RSS content.

7. The method of claim 1 further comprising:
receiving RSS preferences from a user; and
creating prioritization rules in dependence upon the RSS preferences for synthesizing RSS content.

8. A system for email management and rendering, the system comprising:
a computer processor;
a computer memory operatively coupled to the computer processor, the computer memory having disposed within it computer program instructions capable of:
receiving aggregated RSS content in native form,
synthesizing the items of the aggregated native form RSS content into synthesized RSS content; and
presenting the synthesized RSS content.

9. The system of claim 8 wherein the computer memory also has disposed within it computer program instructions capable of translating aspects of the items of the aggregated native form RSS content into uniform text and markup.

10. The system of claim 8 wherein the computer memory also has disposed within it computer program instructions capable of aggregating RSS content in native form including:
computer program instructions capable of identifying new items in an RSS feed in native form; and
computer program instructions capable of retrieving the identified new items from an RSS content source.

11. The system of claim 10 wherein the computer memory also has disposed within it computer program instructions capable of:
identifying the new items in dependence upon RSS aggregation preferences from a user.

12. The system of claim 10 wherein the computer memory also has disposed within it computer program instructions capable of:
retrieving the new items in dependence upon RSS aggregation preferences from a user.

13. The system of claim 8 wherein the computer memory also has disposed within it computer program instructions capable of:
identifying, according to prioritization rules, priority characteristics in the aggregated native form RSS content;
prioritizing the items of the synthesized RSS content according to the priority characteristics; and
presenting the synthesized RSS content further comprises presenting the prioritized synthesized RSS content.

14. The system of claim 8 wherein the computer memory also has disposed within it computer program instructions capable of:
receiving RSS preferences from a user; and
creating prioritization rules in dependence upon the RSS preferences for synthesizing RSS content.

15. A computer program product for management and rendering of RSS content, the computer program product embodied on a computer-readable medium, the computer program product comprising:
computer program instructions for receiving aggregated RSS content in native form;
computer program instructions for synthesizing the items of the aggregated native form RSS content into synthesized RSS content; and
computer program instructions for presenting the synthesized RSS content.

16. The computer program product of claim 15 wherein computer program instructions for synthesizing items of the aggregated native form RSS content into synthesized RSS content further comprise computer program instructions for translating aspects of the items of the aggregated native form RSS content into uniform text and markup.

17. The computer program product of claim 15 further comprising computer program instructions for aggregating RSS content in native form including:
computer program instructions for identifying new items in an RSS feed in native form; and
computer program instructions for retrieving the identified new items from an RSS content source.

18. The computer program product of claim 17 wherein computer program instructions for identifying new items in an RSS feed in native form further comprise:
computer program instructions for identifying the new items in dependence upon RSS aggregation preferences from a user.

19. The computer program product of claim 17 wherein computer program instructions for retrieving the identified new items from an RSS content source further comprise:
computer program instructions for retrieving the new items in dependence upon RSS aggregation preferences from a user.

20. The computer program product of claim 15 further comprising:
computer program instructions for identifying, according to prioritization rules, priority characteristics in the aggregated native form RSS content; and wherein:
computer program instructions for synthesizing the items of the aggregated native form RSS content into synthesized RSS content further comprise computer program instructions for prioritizing the items of the synthesized RSS content according to the priority characteristics; and
computer program instructions for presenting the synthesized RSS content further comprises presenting the prioritized synthesized RSS content.

21. The computer program product of claim 15 further comprising:
computer program instructions for receiving RSS preferences from a user; and
computer program instructions for creating prioritization rules in dependence upon the RSS preferences for synthesizing RSS content.
